(19) United States
(12) Patent Application Publication
(10) Pub. No.: US 2026/0340302 A1
(43) Pub. Date: Oct. 29, 2026

(54) NATURAL LANGUAGE PROCESSING WITH CONTACT CENTER DATA

(71) Applicant: AFINITI AI LIMITED, Dublin (IE)

(72) Inventors: Bilge Sipal Sert, Zonguldak (TR); Cem Rifki Aydin, Istanbul (TR); Liuxia WANG, Potomac, MD (US)

(21) Appl. No.: 18/997,469

(22) PCT Filed: Jul. 21, 2023
(86) PCT No.: PCT/US23/28313

§ 371 Date: Jan. 21, 2025

Related U.S. Application Data
(60) Provisional application No. 63/391,582, filed on Jul. 22, 2022.
(60) Provisional application No. 63/376,631, filed on Sep. 22, 2022.

(51) Int. Cl. G06F 40/40; G06N 3/0455; H04M 3/42; H04M 3/51

(52) U.S. Cl. CPC G06F 40/40; G06N 3/0455; H04M 3/42221; H04M 3/5175

(57) ABSTRACT

The present disclosure relates to natural language processing of contact center transcript data. Particularly, but not exclusively, the present disclosure relates to natural language processing techniques for automatically labeling contact center transcript data. More particularly, but not exclusively, the present disclosure relates to forming a pairing model from labeled contact center transcript data.

### RELATED APPLICATIONS

This application claims the benefit of U.S. Provisional Application No. 63/376,631 (filed on Sep. 22, 2022) and U.S. Provisional Application No. 63/391,582 (filed on Jul. 22, 2022). The entirety of each of the foregoing provisional applications is incorporated by reference herein.

### TECHNICAL FIELD

The present disclosure relates to natural language processing of contact center transcript data. Particularly, but not exclusively, the present disclosure relates to natural language processing techniques for automatically labeling contact center transcript data. More particularly, but not exclusively, the present disclosure relates to forming a pairing model from labeled contact center transcript data.

### BACKGROUND

In many contact center systems, an agent may conduct or present one or more actions or offers to a contact as part of an interaction (e.g., a call between the agent and the contact). It is difficult for the agent to choose the most relevant or appropriate action or offer; this problem is exacerbated when the number of possible actions or offers available for the agent to suggest is large (e.g., one hundred or more). This difficulty may lead to suboptimal actions or offers being suggested which may increase the interaction time, result in suboptimal action/offer allocation for other agents in the contact center, and cause inefficient use of the contact center resources, as the contact will not be offered the most appropriate action or offer for their situation; further, the contact's selection of an offer/action may restrict access to the offer/action for future contacts of the contact center system.

It may be useful to understand historical call data in order to determine pairing models for the contact center system, or in order to determine which offers or actions an agent should conduct or present to a contact. However, several challenges exist. For example, there are several drawbacks in processing transcript data to find the actions or products discussed in an interaction between an agent and a contact. Such transcript data is inherently noisy due to factors such as the speech transcription engine incorrectly identifying words (e.g., as a result of the variety of human accents involved in interactions within a call center). Secondly, action data is typically labeled only for transcripts which are associated with a known outcome—that is, an action or offer has been proposed and accepted. Prior art techniques do not consider actions or offers which are proposed within an interaction but not accepted.

Therefore, there is a need for improved techniques for forming pairing models from natural language transcript data.

### BRIEF DESCRIPTION OF DRAWINGS

To facilitate a fuller understanding of the present disclosure, reference is now made to the accompanying drawings, in which like elements are referenced with like numerals. These drawings should not be construed as limiting the present disclosure, but are intended to be illustrative only.

FIGS. 1A and 1B show block diagrams of contact assignment centers according to embodiments of the present disclosure;

FIGS. 2A-2C show block diagrams of a contact assignment center system according to embodiments of the present disclosure;

FIG. 3 shows a pairing module according to an aspect of the present disclosure;

FIG. 4 shows a plurality of transcripts from which a pairing model may be formed according to embodiments of the present disclosure;

FIG. 5 illustrates action probabilities determined using a first approach and a second approach according to embodiments of the present disclosure;

FIG. 6 shows a transcript labeling pipeline according to an aspect of the present disclosure;

FIG. 7 shows a training process for training a transcript labeling pipeline according to an aspect of the present disclosure;

FIG. 8 shows a method for decisioning behavioral pairing in a contact center system according to an aspect of the present disclosure;

FIGS. 9A and 9B show methods for determining label vectors from relevant transcripts according to aspects of the present disclosure;

FIG. 10 shows a method for training a transcript labeling pipeline according to an aspect of the present disclosure;

FIG. 11 shows a method for automatic vectorization of plain-text transcript data according to an aspect of the present disclosure; and

FIG. 12 shows a table of results for various classification approaches applied to a noisy transcript data set.

### DETAILED DESCRIPTION

A typical contact assignment system algorithmically assigns contacts arriving at a contact assignment center to agents available to handle those contacts. At times, the contact assignment center may be in an “L1 state” and have agents available and waiting for assignment to contacts. At other times, the contact assignment center may be in an “L2 state” and have contacts waiting in one or more queues for an agent to become available for assignment. At yet other times, the contact assignment system may be in an “L3” state and have multiple agents available and multiple contacts waiting for assignment. An example of a contact assignment system is a contact center system that receives contacts (e.g., telephone calls, internet chat sessions, emails, etc.) to be assigned to agents.

In some traditional contact assignment centers, contacts (e.g., callers) are assigned to agents ordered based on time of arrival, and agents receive contacts ordered based on the time when those agents became available. This strategy may be referred to as a “first-in, first-out,” “FIFO,” or “round-robin” strategy. For example, in an L2 environment, when an agent becomes available, the contact at the head of the queue would be selected for assignment to the agent. In other traditional contact assignment centers, a performance-based routing (PBR) strategy for prioritizing higher-performing agents for contact assignment may be implemented. Under PBR, for example, the highest-performing agent among available agents receives the next available contact.

The present disclosure refers to optimized strategies, such as “Behavioral Pairing” or “BP” strategies, for assigning contacts to agents that improve upon traditional assignment methods. BP targets balanced utilization of agents while simultaneously improving overall contact assignment center performance potentially beyond what FIFO or PBR methods will achieve in practice. This is a remarkable achievement inasmuch as BP acts on the same contacts and same agents as FIFO or PBR methods, approximately balancing the utilization of agents as FIFO provides, while improving overall contact assignment center performance beyond what either FIFO or PBR provide in practice. BP improves performance by assigning agent and contact pairs in a fashion that takes into consideration the assignment of potential subsequent agent and contact pairs such that, when the benefits of all assignments are aggregated, they may exceed those of FIFO and PBR strategies.

Various BP strategies may be used, such as a diagonal model BP strategy or a network flow (or “off-diagonal”) BP strategy. These contact assignment strategies and others are described in detail for a contact center context in, e.g., U.S. Pat. Nos. 9,300,802; 9,781,269; 9,787,841; and 9,930,180; all of which are hereby incorporated by reference herein. BP strategies may be applied in an L1 environment (agent surplus, one contact; select among multiple available/idle agents), an L2 environment (contact surplus, one available/idle agent; select among multiple contacts in queue), and an L3 environment (multiple agents and multiple contacts; select among pairing permutations).

The various BP strategies discussed above may be considered two-dimensional (2-D), where one dimension relates to the agents, and the second dimension relates to the contacts (e.g., callers), and the various BP strategies take into account information about agents and contacts to pair them. As explained in detail below, embodiments of the present disclosure relate to decisioning BP strategies that account for higher-dimensional assignments. For a three-dimensional (3-D) example, the BP strategy may assign an agent to both a contact and a set of actions the agent can take or a set of offers the agent can make during the contact assignment.

These decisioning BP strategies may also consider historical outcome data for, e.g., agent-contact-actions or agent-contact-offers pairings to build a BP model and apply a BP strategy to “pair” a contact with an agent and a specific action and/or specific offer set (throughout the specification, the noun and verb “pair” and other forms such as “Behavioral Pairing” may be used to describe triads and higher-dimensional groupings).

In use, the various BP strategies cause the contact assignment system to change operations resulting in the contact assignment system behaving in a new way. As will be described in more detail below, assigning a contact to an agent according to a pairing strategy results in technical changes to the operation of the contact assignment system (e.g., instructions are sent to one or more switches within the contact assignment system to connect the contact to the agent) which causes the contact assignment system to function in a new improved way.

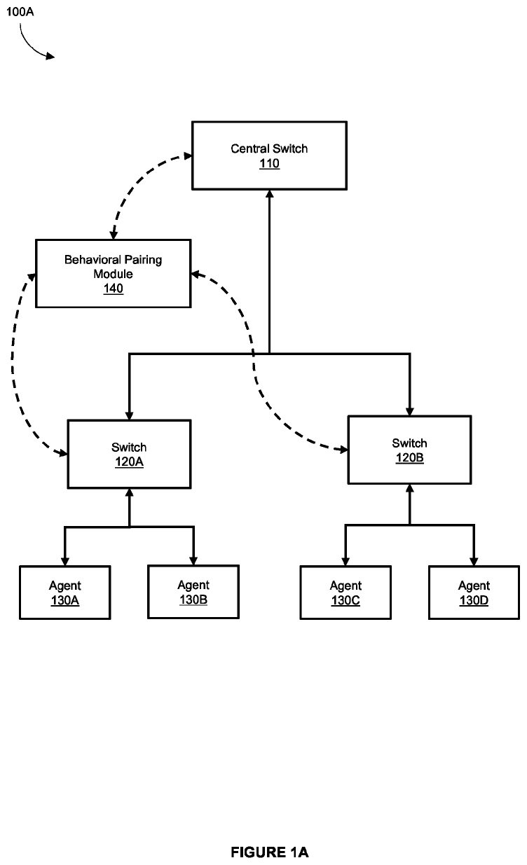

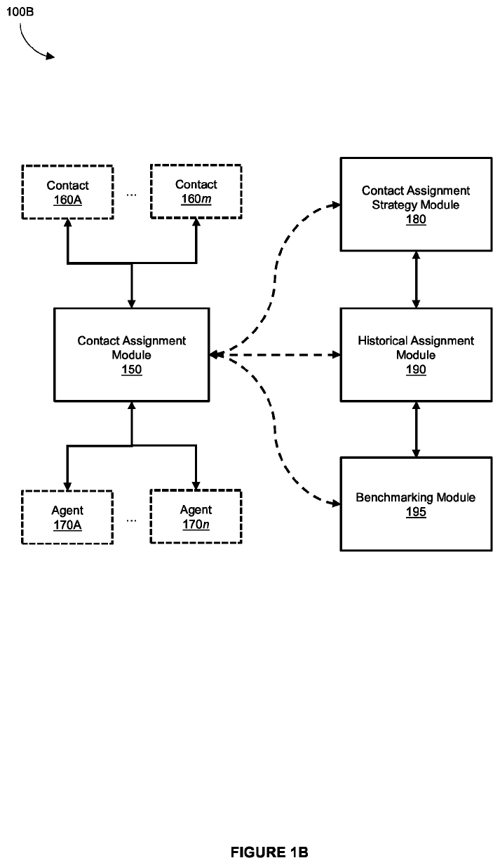

FIG. 1A shows a block diagram of a contact assignment center 100A according to embodiments of the present disclosure.

The description herein describes network elements, computers, and/or components of a system and method for pairing strategies and natural language processing in a contact assignment system that may include one or more modules. As used herein, the term “module” may be understood to refer to computing software, firmware, hardware, and/or various combinations thereof. Modules, however, are not to be interpreted as software which is not implemented on hardware, firmware, or recorded on a non-transitory processor readable recordable storage medium (i.e., modules are not software per se). It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

As shown in FIG. 1, the contact assignment center 100A may include a central switch 110. The central switch 110 may receive incoming contacts (e.g., telephone calls, internet chat sessions, emails, etc.) or support outbound connections to contacts via a dialer, a telecommunications network, or other modules (not shown). The central switch 110 may include routing hardware and software for helping to route contacts among one or more subcenters, or to one or more Private Branch Exchange (“PBX”) or Automatic Call Distribution (ACD) routing components or other queuing or switching components within the contact assignment center 100A. The central switch 110 may not be necessary if there is only one subcenter, or if there is only one PBX or ACD routing component in the contact assignment center 100.

If more than one subcenter is part of the contact assignment center 100A, each subcenter may include at least one switch (e.g., switches 120A and 120B). The switches 120A and 120B may be communicatively coupled to the central switch 110. Each switch for each subcenter may be communicatively coupled to a plurality (or “pool”) of agents. Each switch may support a certain number of agents (or “seats”) to be logged in at one time. At any given time, a logged-in agent may be available and waiting to be connected to a contact, or the logged-in agent may be unavailable for any of a number of reasons, such as being connected to another contact, performing certain post-call functions such as logging information about the call, or taking a break. In the example of FIG. 1, the central switch 110 routes contacts to one of two subcenters via switch 120A and switch 120B, respectively. Each of the switches 120A and 120B are shown with two agents each. Agents 130A and 130B may be logged into switch 120A, and agents 130C and 130D may be logged into switch 120B.

The contact assignment center 100A may also be communicatively coupled to an integrated service from, for example, a third-party vendor. In the example of FIG. 1, behavioral pairing module 140 may be communicatively coupled to one or more switches in the switch system of the contact assignment center 100A, such as central switch 110, switch 120A, and switch 120B. In some embodiments, switches of the contact assignment center 100A may be communicatively coupled to multiple behavioral pairing modules. In some embodiments, behavioral pairing module 140 may be embedded within a component of the contact assignment center 100A (e.g., embedded in or otherwise integrated with a switch).

Behavioral pairing module 140 may receive information from a switch (e.g., switch 120A) about agents logged into the switch (e.g., agents 130A and 130B) and about incoming contacts via another switch (e.g., central switch 110) or, in some embodiments, from a network (e.g., the Internet or a telecommunications network) (not shown). The behavioral pairing module 140 may process this information to determine which agents should be paired (e.g., matched, assigned, distributed, routed) with which contacts along with other dimensions (e.g., offers, actions, channels, non-monetary rewards, monetary rewards or compensation, physical resources, proxies for physical resources, etc.). Once it is determined which agents should be paired with which contacts, the behavioral pairing module 140 may send one or more instructions to the relevant switch(es) to connect the agent to the contact thereby resulting in a change of state in the contact assignment center 100A. Therefore, the pairing module 140 causes a direct change in how the contact assignment center 100A operates.

For example, in an L1 state, multiple agents may be available and waiting for connection to a contact, and a contact arrives at the contact assignment center 100A via a network or the central switch 110. As explained above, without the behavioral pairing module 140, a switch will typically automatically distribute the new contact to whichever available agent has been waiting the longest amount of time for an agent under a FIFO strategy, or whichever available agent has been determined to be the highest-performing agent under a PBR strategy. In one example of a behavioral pairing module 140, contacts and agents may be given scores (e.g., percentiles or percentile ranges/bandwidths) according to a pairing model or other artificial intelligence data model, so that a contact may be matched, paired, or otherwise connected to a preferred agent. The higher-dimensional analysis of BP decisioning will be explained in more detail below.

In an L2 state, multiple contacts are available and waiting for connection to an agent, and an agent becomes available. These contacts may be queued in a switch such as a PBX or ACD device. Without the behavioral pairing module 140, a switch will typically connect the newly available agent to whichever contact has been waiting on hold in the queue for the longest amount of time as in a FIFO strategy or a PBR strategy when agent choice is not available. In some contact assignment centers, priority queuing may also be incorporated, as previously explained. In one example of a behavioral pairing module 140 in this L2 scenario, as in the L1 state described above, contacts and agents may be given percentiles (or percentile ranges/bandwidths, etc.) according to, for example, a model, such as an artificial intelligence model, so that an agent becoming available may be matched, paired, or otherwise connected to a preferred contact. The higher-dimensional analysis of BP decisioning will be explained in more detail below.

FIG. 1B shows a block diagram of a contact assignment system 100B according to embodiments of the present disclosure.

The contact assignment system 100B may be included in a contact assignment center (e.g., contact assignment center 100A) or incorporated in a component or module (e.g., behavioral pairing module 140) of a contact assignment center for helping to assign agents among various contacts and other dimensions for grouping.

The contact assignment system 100B may include a contact assignment module 150 that is configured to pair (e.g., match, assign) incoming contacts to available agents. (The higher-dimensional analysis of BP decisioning will be explained in more detail below.) In the example of FIG. 1B, m contacts 160A-160m are received over a given period, and n agents 170A-170n are available during the given period. Each of the m contacts may be assigned to one of the n agents for servicing or other types of contact processing. In the example of FIG. 1B, m and n may be arbitrarily large finite integers greater than or equal to one. In a real-world contact assignment center, such as a contact center, there may be dozens, hundreds, etc. of agents logged into the contact center to interact with contacts during a shift, and the contact center may receive dozens, hundreds, thousands, etc. of contacts (e.g., telephone calls, internet chat sessions, emails, etc.) during the shift.

In some embodiments, a contact assignment strategy module 180 may be communicatively coupled to and/or configured to operate in the contact assignment system 200. The contact assignment strategy module 180 may implement one or more contact assignment strategies (or “pairing strategies”) for assigning individual contacts to individual agents (e.g., pairing contacts with contact center agents). A variety of different contact assignment strategies may be devised and implemented by the contact assignment strategy module 180. In some embodiments, a FIFO strategy may be implemented in which, for example, the longest-waiting agent receives the next available contact (in L1 environments) or the longest-waiting contact is assigned to the next available agent (in L2 environments). In other embodiments, a PBR strategy for prioritizing higher-performing agents for contact assignment may be implemented. Under PBR, for example, the highest-performing agent among available agents receives the next available contact. In yet other embodiments, a BP strategy may be used for optimally assigning contacts to agents using information about either contacts or agents, or both. Various BP strategies may be used, such as a diagonal model BP strategy or a network flow (“off-diagonal”) BP strategy. See U.S. Pat. Nos. 9,300,802; 9,781,269; 9,787,841; and 9,930,180.

In some embodiments, the contact assignment strategy module 180 may implement a decisioning BP strategy that takes into account the next-best action for a contact, when the contact is assigned to a particular agent. For a contact-agent pair, the decisioning BP strategy may also assign an action or set of actions available to the agent to complete the contact. In the context of a contact center system, the action or set of actions may include an offer or a set of offers that the agent may present to a customer. For example, in a contact center system, a decisioning BP strategy may pair a contact with an agent along with an action or set of agents (e.g., an offer or set of offers) available to the agent to make to a customer, based on the expected outcome of the contact-agent interaction using that particular action or set of actions. By influencing the choices or options among actions available to an agent, a decisioning BP strategy goes beyond pairing a contact to an agent by optimizing the outcome of the individual interaction between the agent and the contact.

For example, if agent 170A loves sports, agent 170A may be more adept at selling sports packages. Therefore, sports packages may be included in agent 170A's set of offers for some or all contact types. On the other hand, agent 170B may love movies and may be more adept at selling premium movie packages; so premium movie packages may be included in agent 170B's set of offers for some or all contact types. Further, based on an artificial intelligence process such as machine learning, a decisioning BP model may automatically segment customers over a variety of variables and data types. For example, the decisioning BP model may recommend offering a package that includes sports to a first type of customer (“Customer Type 1”) that may fit contacts of that particular type. The decisioning BP model may recommend offering a premium movie package to a second type of customer (“Customer Type 2”) that may fit a contact type. A decisioning BP strategy may preferably pair a Customer Type 1 with agent 170A and an offer set with a sports package, and a Customer Type 2 with agent 170B and an offer set with a premium movie package. This results in a change in state of the contact assignment system 100B by causing connections to be formed between the contacts and the agents based on the pairing determined by the decisioning BP strategy. Thus, the changes in the pairings ultimate cause the contact assignment system 100B to operate in a different manner.

As with previously-disclosed BP strategies, a decisioning BP strategy optimizes the overall performance of the contact assignment system rather than every individual instant contact-agent pairing. For instance, in some embodiments, a decisioning BP system will not always offer sports to a Customer Type 1, nor will agent 170A always be given the option of offering deals based on a sports package. Such a scenario may arise when a marketing division of a company running a contact center system may have a budget for a finite, limited number of deals (e.g., a limited number of discounted sports packages), other constraints on the frequency of certain offers, limits on the total amount of discounts (e.g., for any discount or discounted package) that can be made over a given time period, etc. Similarly, deals based on sports may sometimes be offered to a Customer Type 2, and agent 170B may sometimes be given the option of offering deals based on a sports package.

To optimize the overall performance of the contact assignment system, a decisioning BP strategy may account for all types of customers waiting in a queue, agents available for customers, and any other dimensions for pairing such as the number and types of offers remaining, agent compensation or other non-monetary rewards, next-best actions, etc. In some embodiments, a probability distribution may be assigned based on the likelihood that an incoming contact or customer type will accept a given offer level based on the agent being paired with the contact or customer.

For example, for a Contact Type 1, if the discount offered is 0%, the likelihood of a contact of Contact Type 1 accepting the offer from an average agent is 0%, and the likelihood of accepting the offer specifically from agent 170A is also 0% and from agent 170B is also 0%. For a 20% discount offer, the likelihood of the contact of Contact Type 1 accepting the offer from an average agent may be 30%, whereas the likelihood of said contact of Contact Type 1 accepting the offer from agent 170A may be 60% and from agent 170B may be 25%. In a scenario where an average agent, agent 170A, and agent 170B are all assigned to the queue and available, it is possible for agent 170A to perform much higher than the average agent or agent 170B.

In some embodiments, an output measurement may be attached to each contact before and after interaction with an agent. For example, a revenue number may be attached to each caller pre- and post-call. A decisioning BP system may measure the change in revenue and the influenceability of a contact based on an offer or a set of offers presented by an agent. For example, a Contact Type 1 may be more likely to renew her existing plan regardless of the discount offered, or regardless of the ability of the individual agent. A Contact Type 2 may be preferably assigned to a lower-performing agent with a higher cap on discounts in the offer set. In contrast, a Contact Type 2 may be more likely to upgrade her plans if she were paired with a higher-performing agent or an agent authorized to offer steeper discounts.

In some embodiments, a decisioning BP strategy may make sequential pairings of one or more dimensions in an arbitrary order. For example, the decisioning BP strategy may first pair an agent to a contact and then pair an offer set to the agent-contact pairing, then pair a reward to the agent-contact-offer set pairing, and so on.

In other embodiments, a decisioning BP strategy may make “fully-coupled,” simultaneous multidimensional pairings. For example, the decisioning BP strategy may consider all dimensions at once to select an optimal 4-D agent-contact-offers-reward pairing.

The same contact may arrive at the contact assignment system multiple times (e.g., the same caller calls a call center multiple times). In these “multi-touch” scenarios, in some embodiments, the contact assignment system may always assign the same item for one or more dimensions to promote consistency. For example, if a contact is paired with a particular action or action set the first time the contact arrives, the contact will be paired with the same action or action set each subsequent time the contact arrives (e.g., for a given issue, within a given time period, etc.).

In some embodiments, a historical assignment module 190 may be communicatively coupled to and/or configured to operate in the contact assignment system 100B via other modules such as the contact assignment module 150 and/or the contact assignment strategy module 180. The historical assignment module 190 may be responsible for various functions such as monitoring, storing, retrieving, and/or outputting information about contact-agent assignments and higher-dimensional assignments that have already been made. For example, the historical assignment module 190 may monitor the contact assignment module 150 to collect information about contact assignments in a given period. Each record of a historical contact assignment may include information such as an agent identifier, a contact or contact type identifier, action or action set identifier (e.g., offer or offer set identifier), outcome information, or a pairing model identifier (i.e., an identifier indicating whether a contact assignment was made using a BP strategy, a decisioning BP strategy, or some other pairing model such as a FIFO or PBR pairing model).

In some embodiments and for some contexts, additional information may be stored. For example, in a call center context, the historical assignment module 190 may also store information about the time a call started, the time a call ended, the phone number dialed, and the caller's phone number.

In some embodiments, the historical assignment module 190 may generate a pairing model, a decisioning BP model, or similar computer processor-generated model based on a set of historical assignments for a period of time (e.g., the past week, the past month, the past year, etc.), which may be used by the contact assignment strategy module 180 to make contact assignment recommendations or instructions to the contact assignment module 150.

In some embodiments, instead of relying on predetermined action sets in generating a decisioning BP model, the historical assignment module 190 may analyze historical outcome data to create or determine new or different offer sets, which are then incorporated into the decisioning BP model. This approach may be preferred when there are limitations on the number of a particular action set that may be made. For example, the marketing division may have limited the contact center system to five hundred discounted sports packages and five hundred discounted movie packages per month, and the company may want to optimize total revenue irrespective of how many sports and movie packages are sold, with or without a discount. Under such a scenario, the decisioning BP model may be similar to previously-disclosed BP diagonal models, except that, in addition to the “contact or contact percentile” (CP) dimension and the “agent percentile” (AP) dimension, there may be a third “revenue or offer set percentile” dimension. Moreover, all three dimensions may be normalized or processed with mean regression (e.g., Bayesian mean regression (BMR) or hierarchical BMR).

In some embodiments, the historical assignment module 190 may generate a decisioning BP model that optimizes contact-agent-offer set pairing based on individual channels or multi-channel interactions. The historical assignment module 190 may treat different channels differently. For example, a decisioning BP model may preferably pair a contact with different agents or action sets depending on whether the contact calls a call center, initiates a chat session, sends an email or text message, enters a retail store, etc.

In some embodiments, the contact assignment strategy module 180 may proactively create contacts or other actions (e.g., recommend outbound contact interactions, next-best actions, etc.) based on information about a contact or a customer, available agents, and available offer sets. For example, the contact assignment system 100B may determine that a customer's contract is set to expire, the customer's usage is declining, or the like. The contact assignment system 100B may further determine that the customer is unlikely to renew the contract at the customer's current rate (e.g., based on information from the historical assignment module 190). The contact assignment system 100B may determine that the next-best action is to call the customer (contact selection, channel selection, and timing selection), connect with a particular agent (agent selection), and give the agent the option to offer a downgrade at a particular discount or range of discounts (offer set selection). If the customer does not come to an agreement during the call, the contact assignment system 100B may further determine that this customer is more likely to accept a downgrade discount offer if the agent follows up with a text message with information about the discount and how to confirm (multi-channel selection and optimization).

In some embodiment, similar to how a Kappa (K) parameter is used to adjust/skew the agent percentile or percentile range (see U.S. Pat. No. 9,781,269) and how a Rho (p) parameter is used to adjust/skew the contact or contact percentile or percentile range (see U.S. Pat. No. 9,787,841), the contact assignment strategy module 180 may apply an Iota (L) parameter to a third (or higher) dimension such as the action or action set percentile or percentile range in a decisioning BP strategy. With the Iota parameter, the contact assignment strategy module 180 may, for example, adjust the action or action set percentile or percentile range (or other dimensions) to skew contact-agent-action pairing toward higher-performing actions and imbalance action set availability. The Iota parameter may be applied in either L1 or L2 environment and may be used in conjunction with Kappa or Rho parameter, or it may be applied with both Kappa and Rho parameters in an L3 environment. For example, if the contact assignment strategy module 180 determines that the expected wait time for a contact has exceeded 100 seconds (high congestion), it may apply the Iota parameter so that an agent is more likely to have more relevant actions available to offer, which are likely to be accepted or taken more quickly to reduce congestion and the expected wait time. This can speed up contact-agent interaction, thereby reducing average handle time (AHT), and reducing overall memory and network bandwidth constraints at the contact center system. When congestion is low, expected wait time may be low, and the Iota parameter may be adjusted to make only less generous offers available.

In some embodiments, the contact assignment strategy module 180 may optimize performance by optimizing for multiple objectives or other goals simultaneously. Where the objectives are competing (e.g., discount amount and retention rates), the contact assignment strategy module 180 may balance the tradeoff between the two objectives. For example, the contact assignment strategy module 180 may balance increasing (or maintaining) revenue with maintaining or minimally decreasing retention rates, or it may balance decreasing (or maintaining) AHT with increasing (or maintaining) customer satisfaction, etc.

In some embodiments, the contact assignment strategy module 180 may implement a decisioning BP strategy that takes into account agent compensation in lieu of an offer or offer set. The framework is similar to the description above, except that, instead of influencing a customer with an offer or offer set, the decisioning BP strategy influences the performance of an agent with a compensation that the agent may receive. In other words, instead of the contact-agent-offer set three-dimensional pairing, the decisioning BP strategy makes a three-dimensional pairing of contact-agent-reward. In some embodiments, a decisioning BP strategy may make a four-way pairing of contact-agent-offer-reward.

A decisioning BP strategy being capable of providing variable agent compensation based on contact-agent pairing may lead to better transparency and fairness. For example, some contact assignment (e.g., contact center) systems may see a mix of more challenging and less challenging contacts and employ a mix of higher-performing and lower-performing agents. Under a FIFO strategy or a PBR strategy, agents of any ability are equally likely to be paired with more or less challenging contacts. Under a FIFO strategy, the overall performance of the contact center system may be low, but the average agent compensation may be transparent and fair. Under a PBR strategy, agent utilization may be skewed, and compensation may also be skewed toward higher-performing agents. Under previously-disclosed BP strategies, a more challenging contact type may be preferably paired with a higher-performing agent, whereas a less challenging contact type may be preferably paired with a lower-performing agent. For example, if a high-performing agent gets more difficult calls on average, this “call type skew” may result in the high-performing agent's conversion rate going down and compensation going down.

Therefore, adjusting an agent's compensation up or down for a given contact (or contact) types may improve the fairness of compensation under the previously-disclosed BP strategies. When an agent is paired with a contact or contact, a decisioning BP strategy may inform the agent of the expected value of the contact to the contact center and/or how much the agent will receive as a commission or other non-monetary reward for handling the contact or achieving a particular outcome. The decisioning BP strategy may influence the agent's behavior through offering variable compensation. For example, if the decisioning BP strategy determines that the agent should process the contact quickly (lower AHT, lower revenue), the decisioning BP strategy may select a lower compensation. Consequently, the agent may have less incentive to spend a lot of time earning a relatively lower commission. In contrast, if the decisioning BP strategy determines that the agent should put high effort into a higher value call (higher AHT, higher revenue), it may select a higher compensation. Such a decisioning BP strategy may maximize an agent's reward while improving the overall performance of the contact assignment system 100B.

The historical assignment module 190 may model a decisioning BP model based on historical information about contact types, agents, and compensation amounts so that a simultaneous selection of contact-agent-reward may be made. The amount of variation in compensation up or down may vary and depend on each combination of an individual agent and contact type, with the goal of improving the overall performance of the contact assignment system 100B.

Similar to applying the Iota parameter to the offer set or next-best action percentile or percentile range dimension, and as noted above, the contact assignment strategy module 180 may apply an Iota parameter to other dimensions, such as skewing agent compensation to a greater or lesser degree, or to generally higher or generally lower values. In some embodiments, the amount and type of Iota parameter applied to agent compensation or other non-monetary rewards may be based at least in part on factors in the contact assignment system 100B (e.g., the expected wait time of callers on hold in a call center).

In some embodiments that employ strategies that are similar to the diagonal model BP strategy, a variable compensation may be viewed as temporarily influencing the effective agent percentile (AP) of an available agent to be higher or lower, in order to move an available contact-agent pairing closer to the optimal diagonal. Similarly, adjusting the value of offers to be higher or lower may be viewed as influencing the effective contact percentile (CP) of a waiting contact to be higher or lower, in order to move an available contact-agent pairing closer to the optimal diagonal.

In some embodiments, a benchmarking module 195 may be communicatively coupled to and/or configured to operate in the contact assignment system 100B via other modules such as the contact assignment module 150 and/or the historical assignment module 190. The benchmarking module 195 may benchmark the relative performance of two or more pairing strategies (e.g., FIFO, PBR, BP, decisioning BP, etc.) using historical assignment information, which may be received from, for example, the historical assignment module 190. In some embodiments, the benchmarking module 195 may perform other functions, such as establishing a benchmarking schedule for cycling among various pairing strategies, tracking cohorts (e.g., base and measurement groups of historical assignments), etc. Benchmarking is described in detail for the contact center context in, e.g., U.S. Pat. No. 9,712,676, which is hereby incorporated by reference herein.

In some embodiments, the benchmarking module 195 may output or otherwise report or use the relative performance measurements. The relative performance measurements may be used to assess the quality of the contact assignment strategy to determine, for example, whether a different contact assignment strategy (or a different pairing model) should be used, or to measure the overall performance (or performance gain) that was achieved within the contact assignment system 100B while it was optimized or otherwise configured to use one contact assignment strategy instead of another.

In some embodiments, the benchmarking module 195 may benchmark a decisioning BP strategy against one or more alternative pairing strategies such as FIFO in conjunction with offer set availability. For example, in a contact center system, agents may have a matrix of nine offers-three tiers of service levels, each with three discount levels. During “off” calls, the longest-waiting agent may be connected to the longest-waiting caller, and the agent may offer any of the nine offers. A high-performing agent may be more likely to sell a higher tier of service at a higher price, whereas a lower-performing agent may not try as hard and go immediately to offering the biggest discounts. During “on” calls, the decisioning BP strategy may pair contacts with agents but limit agents to a subset of the nine available offers. For example, for some contact types, a higher-performing agent may be empowered to make any of the nine offers, whereas a lower-performing agent may be limited to offer only the smaller discount for certain tiers, if the contact assignment strategy module 180 determines, based on the decisioning BP model, that the overall performance of the contact center system may be optimized by selectively limiting the offer sets in a given way for a given contact-agent pairing. Additionally, if a provider (e.g., vendor) that provides a contact assignment system with decisioning BP strategy uses a benchmarking and revenue sharing business model, the provider may contribute a share of benchmarked revenue gain to the agent compensation pool.

In some embodiments, the contact assignment system 100B may offer dashboards, visualizations, or other analytics and interfaces to improve overall performance of the system. For each agent, the analytics provided may vary depending on the relative ability or behavioral characteristics of an agent. For example, competitive or higher-performing agents may benefit from a rankings widget or other “gamification” elements (e.g., badges or achievements to unlock points and score boards, notifications when agents overtake one another in the rankings, etc.). On the other hand, less competitive or lower-performing agents may benefit from periodic messages of encouragement, recommendations on training/education sessions, etc.

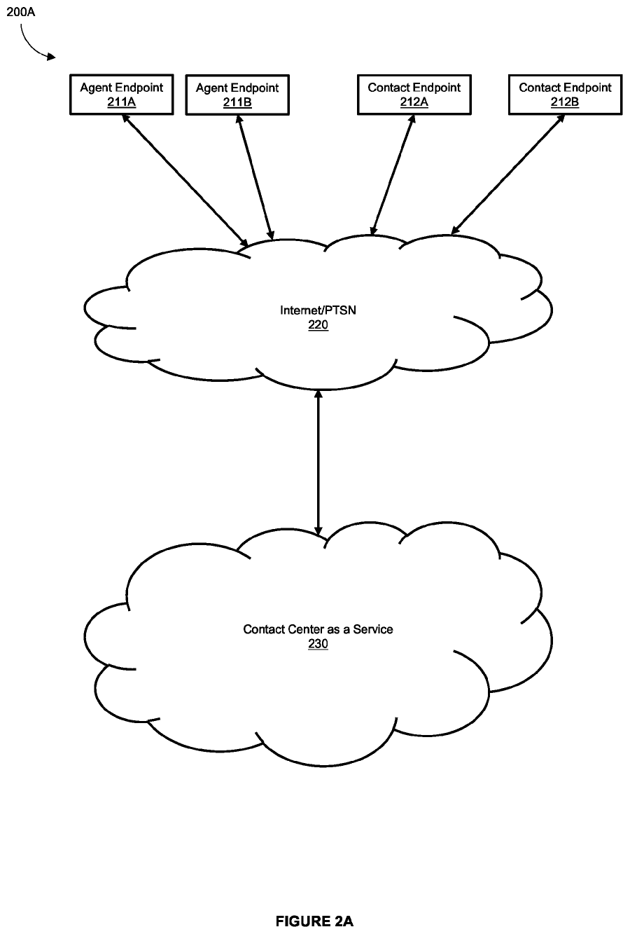

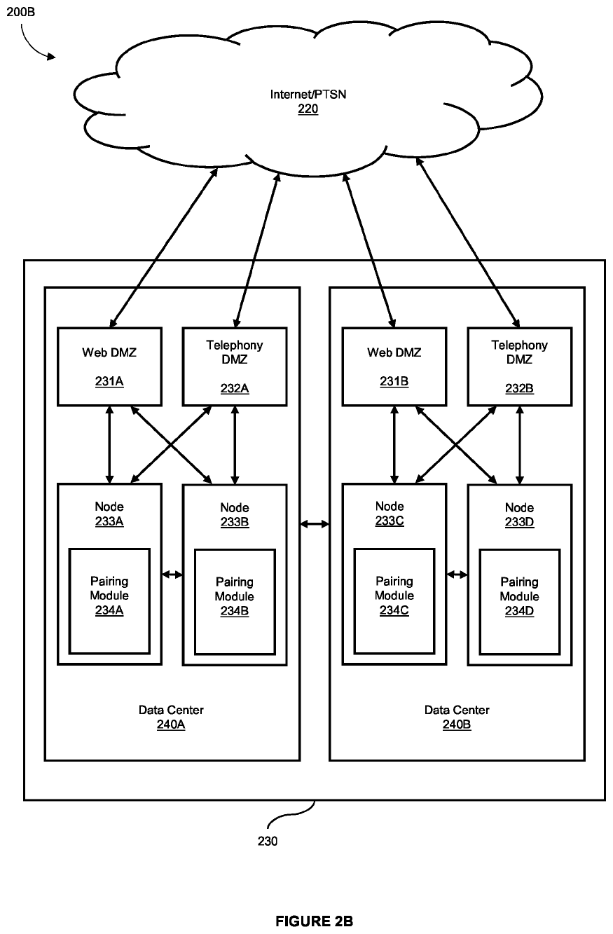

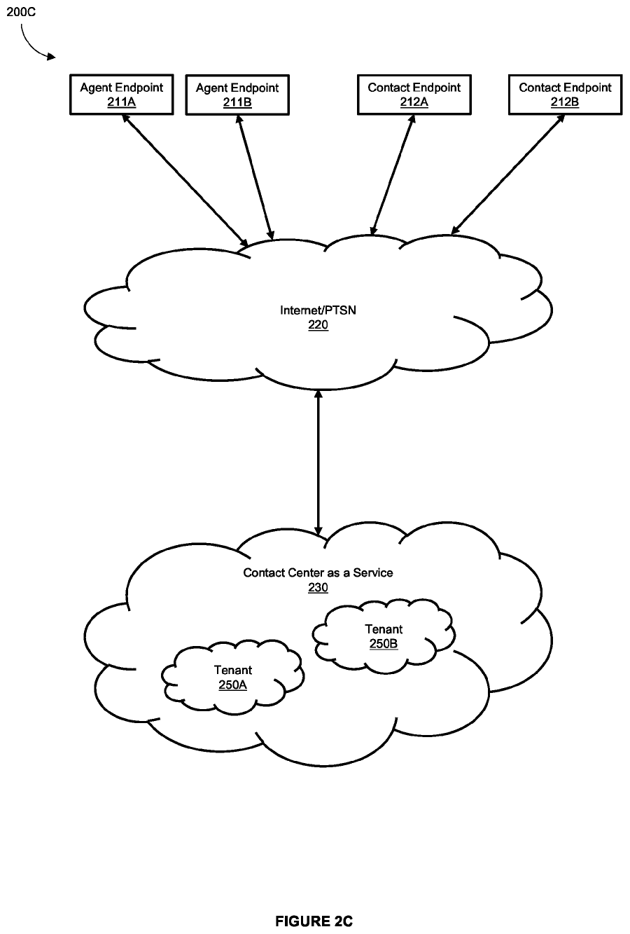

FIG. 2A illustrates a block diagram of an example contact assignment system 200A according to embodiments of the present disclosure.

As shown in FIG. 2A, the contact assignment system 200A may include one or more agent endpoints 211A, 211B and one or more contact endpoints 212A, 212B. The agent endpoints 211A, 211B may include an agent terminal and/or an agent computing device (e.g., laptop, cellphone). The contact endpoints 212A, 212B may include a contact terminal and/or a contact computing device (e.g., laptop, cellphone). Agent endpoints 211A, 211B and/or contact endpoints 212A, 212B may connect to a Contact Center as a Service (CCaaS) 230 through either the Internet or a public switched telephone network (PSTN), according to the capabilities of the endpoint device.

FIG. 2B illustrates an example contact assignment system 200B with an example configuration of a CCaaS 230. For example, a CCaaS 230 may include multiple data centers 240A, 240B. The data centers 240A, 240B may be separated physically, even in different countries and/or continents. The data centers 240A, 240B may communicate with each other. For example, one data center is a backup for the other data center; so that, in some embodiments, only one data center 240A or 240B receives agent endpoints 211A, 211B and contact endpoints 212A, 212B at a time.

Each data center 240A, 240B includes web demilitarized zone equipment 231A and 231B, respectively, which is configured to receive the agent endpoints 211A, 211B and contact endpoints 212A, 212B, which are communicatively connecting to CCaaS 230 via the Internet. Web demilitarized zone (DMZ) equipment 231A and 231B may operate outside a firewall to connect with the agent endpoints 211A, 211B and contact endpoints 212A, 212B while the rest of the components of data centers 240A, 240B may be within said firewall (besides the telephony DMZ equipment 232A, 232B, which may also be outside said firewall). Similarly, each data center 240A, 240B includes telephony DMZ equipment 232A and 232B, respectively, which is configured to receive agent endpoints 211A, 211B and contact endpoints 212A, 212B, which are communicatively connecting to CCaaS 230 via the PSTN. Telephony DMZ equipment 232A and 232B may operate outside a firewall to connect with the agent endpoints 211A, 211B and contact endpoints 212A, 212B while the rest of the components of data centers 240A, 240B (excluding web DMZ equipment 231A, 231B) may be within said firewall.

Further, each data center 240A, 240B may include one or more nodes 233A, 233B, and 233C, 233D, respectively. All nodes 233A, 233B and 233C, 233D may communicate with web DMZ equipment 231A and 231B, respectively, and with telephony DMZ equipment 232A and 232B, respectively. In some embodiments, only one node in each data center 240A, 240B may be communicating with web DMZ equipment 231A, 231B and with telephony DMZ equipment 232A, 232B at a time.

Each node 233A, 233B, 233C, 233D may have one or more pairing modules 234A, 234B, 234C, 234D, respectively. Similar to pairing module 140 of contact assignment center 100A of FIG. 1A, pairing modules 234A, 234B, 234C, 234D may pair contacts to agents. For example, the pairing module may alternate between enabling pairing via a Behavioral Pairing (BP) module and enabling pairing with a First-in-First-out (FIFO) module. In other embodiments, one pairing module (e.g., the BP module) may be configured to emulate other pairing strategies.

In pairing agent endpoints to contact endpoints, a pairing module (e.g., pairing modules 234A, 234B, 234C, 234D) causes a change to the technical state of the contact assignment system 200B. The pairing strategy or pairing model used by a pairing module may result in an improvement to the technical operation of the contact assignment system 200B by utilizing the physical resources of the contact assignment system 200B in a more efficient manner.

Turning now to FIG. 2C, the disclosed CCaaS communication systems (e.g., FIGS. 2A and/or 2B) may support multi-tenancy such that multiple contact centers (or contact center operations or businesses) may be operated on a shared environment. That is, each tenant may have a separate, non-overlapping pool of agents. CCaaS 230 is shown in FIG. 2C as comprising two tenants 250A and 250B. Turning back to FIG. 2B, for example, multi-tenancy may be supported by node 233A supporting tenant 250A while node 233B supports 250B. In another embodiment, data center 240A supports tenant 250A while data center 240B supports tenant 250B. In another example, multi-tenancy may be supported through a shared machine or shared virtual machine; such at node 233A may support both tenants 250A and 250B, and similarly for nodes 233B, 233C, and 233D.

In other embodiments, the system may be configured for a single tenant within a dedicated environment such as a private machine or private virtual machine.

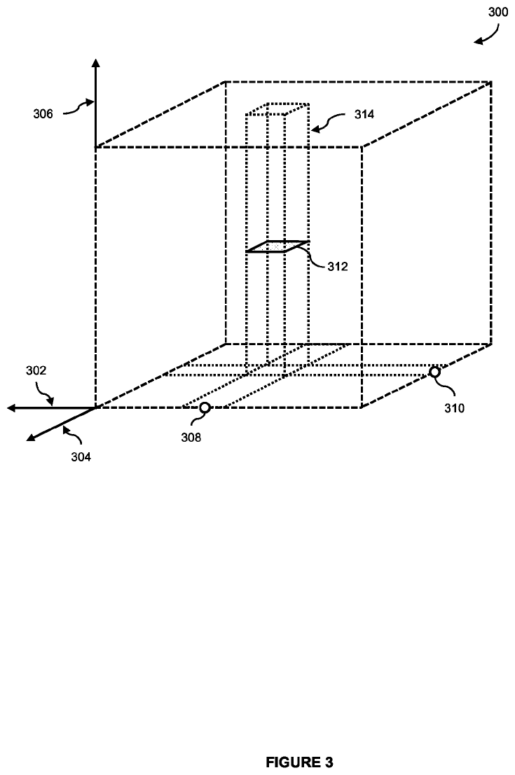

FIG. 3 shows a pairing model 300 according to an aspect of the present disclosure.

The pairing model 300 comprises a plurality of elements, or values, which may be arranged according to an agent dimension 302 (or agent axis, agent percentile dimension/axis), a contact type dimension 304 (or contact type axis, contact dimension/axis, or contact percentile dimension/axis), and an action probability dimension 306 (or action probability axis, action dimension/axis, or action percentile dimension/axis). FIG. 3 further shows a first location 308 of the agent dimension associated with a first agent (e.g., agent 170A in FIG. 1B), a second location 310 of the contact type dimension associated with a first contact type (e.g., “Customer Type 1”), and a third location 312 of the action probability dimension associated with an action probability value. The third location 312 of the action probability dimension is shown as part of a plurality of possible action probability values 314.

The number of elements along the agent dimension 302 of the pairing model 300 may correspond to a number of agents associated with the contact center. For example, the agent dimension 302 may be of size n corresponding to the n agents that are available during a given period (such as agents 170A-170n shown in FIG. 1B). In some embodiments, the agent dimension 302 of the pairing model 300 may be associated with a set of unique agent identifiers.

The number of elements along the contact type dimension 304 of the pairing model 300 may correspond to a number of contact types associated with the contact center. For example, the agent dimension 302 may be of size l corresponding to the l contact types that are related to the contact center. As discussed above, an incoming contact may be assigned a contact type based on an artificial intelligence process such that pairing for the incoming contact is performed on the basis of the assigned contact type. In some embodiments, the contact type dimension 304 of the pairing model 300 may be associated with a set of unique contact types and or may be associated with a set of unique contact identifiers.

The number of elements along the action probability dimension 306 may correspond in size to the number of actions available for the agents to take within the contact center. As such, the action probability dimension 306 may alternatively be referred to as the action dimension or axis, the next action dimension or axis, or the offer dimension or axis. In some embodiments, the action probability dimension 306 of the pairing model 300 may be associated with a set of unique action identifiers.

A specific agent-contact-type-action triple leads to a specific action probability value within the pairing model 300. In the example shown in FIG. 3, an action probability value is shown at the third location 312 which is within the plurality of possible action probability values 314. All action probability values within the plurality of possible action probability values 314 are associated with the first agent (associated with the first location 308 of the agent dimension) and the first contact type (associated with the second location 310 of the contact type dimension). In this example, the action probability value shown at the third location 312 corresponds to the most probable value within the plurality of possible action probability values 314. As such, the action probability value shown at the third location 312 may be understood as being the most likely action to be taken if the agent associated with the first location 308 were paired with a contact of the contact type associated with the second location 310. The pairing model 300 may therefore be used for decisioning behavioral pairing by identifying an action or set of actions available to the agent to complete the contact. By influencing the choices or options among actions available to an agent, a decisioning BP strategy goes beyond pairing a contact to an agent by optimizing the outcome of the individual interaction between the agent and the contact.

Conventional approaches to learning actions or offers and conventional approaches to making determinations about which offers or actions should be suggested focus only on actions which have been accepted (i.e., have a positive outcome). Learning which action or offer to take from only those actions or offers which have been accepted may lead to a skewed or inaccurate representation of the likelihood of an action or offer being accepted. Therefore, conventional techniques for determining actions or offers are inadequate due their usage of only data corresponding to accepted offers. The present disclosure newly presents systems and methods for determining actions and offers based on offers that were rejected by the contact during a contact-agent interaction. According to an aspect of the present disclosure, elements within a pairing model related to agents, contact types, and action probabilities are learnt from call transcript data using a natural language processing pipeline.

The natural language processing approach of the present disclosure is particularly effective because it can form elements of the pairing model from actions which are either exposed or hidden within the transcripts. As will be described in more detail below, exposed actions are those actions which are known because they have been recorded along with an outcome of a particular interaction (e.g., an action was offered by an agent to a contact, and the contact subsequently accepted the action such that the action was recorded as the outcome of the interaction). In contrast, hidden or latent actions are those actions which occur within an interaction but are unknown because they have not been recorded (e.g., because these actions are not associated with a positive outcome such as the action being accepted). These hidden or latent actions are inaccessible to conventional pairing strategies. Forming the pairing model from both exposed and hidden actions leads to a more accurate determination of the probability of a given action being taken thereby resulting in an improved pairing model and improved operations at a contact center.

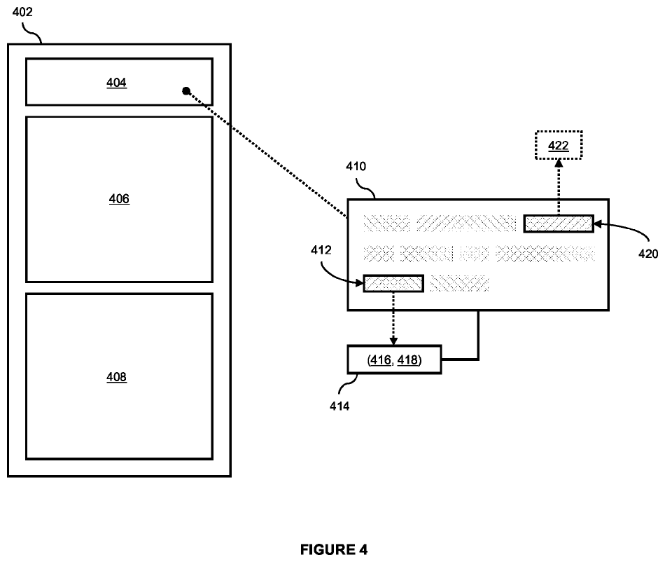

FIG. 4 shows an example transcript which is part of a set of transcripts from which a pairing model may be formed according to embodiments of the present disclosure.

The plurality of transcripts 402 include a first subset of transcripts 404, a second subset of transcripts 406, and third subset of transcripts 408. FIG. 4 further shows an example transcript 410 comprising a first substring 412 with an associated relevant action-outcome pair 414 comprising a relevant action 416 and an outcome 418. The example transcript 410 further comprises a second substring 420 associated with a hidden relevant action 422.

The first subset of transcripts 404 comprises transcripts which are known to relate to a relevant action because they have an associated relevant action-outcome pair. Here, a relevant action is to be understood as an action of the set of all possible actions which is of particular interest for a given task. The second subset of transcripts 406 comprises transcripts which relate to a relevant action, but this relationship is unknown (i.e., because each transcript of the second subset of transcripts 406 do not have an associated relevant action-outcome pair). The third subset of transcripts 408 comprises transcripts which relate to irrelevant actions. The transcripts within the third subset of transcripts may still have associated action-outcome pairs but the action in the action-outcome pair is not a relevant action.

The transcripts within the first subset of transcripts 404 are illustrated by the example transcript 410 which comprises the associated relevant action-outcome pair 414. The associated relevant action-outcome pair 414 comprises the relevant action 416 which the example transcript 410 is known to relate to and the outcome 418 of the relevant action 416. For example, the relevant action may correspond to a product (e.g., “Samsung A20”) offered by the agent to the contact during the call, and the outcome may correspond to the contact accepting the offer of the product. Because the outcome of the call was that the contact accepted the product offer, the product offered (i.e., the relevant action) is known. Thus, for a call transcript with a known outcome, at least one of the actions related to the call transcript is also known.

Although a call transcript may be known to be related to an action, the specific string of text within the plain-text representation of the call transcript, which relates to the action, may not be known. In the example shown in FIG. 4, the first substring 412 of the example transcript 410 is associated with the relevant action 416 in the relevant action-outcome pair 414, but the first substring 412 may not directly correlate with the text of the relevant action 416 and so the exact form of the first substring 412 may not be known. This may be due to several factors.

First, the plain-text transcripts are produced by means of automatic speech-to-text conversion approaches as are known in the art. Whilst such approaches can transcribe large portions of calls with a high-degree of accuracy, the transcripts produced are nevertheless noisy. This noise arises due to a multitude of reasons including artefacts or noise in the original call audio (e.g., due to low quality microphones or unstable/noisy connections caused by limited cellular connectivity), the accent of the agent or contact leading the automatic speech-to-text conversion algorithms incorrectly identifying words, and general transcription errors introduced by the automatic speech-to-text conversion algorithms (e.g., as a result of technical or obscure words being used which fall outside of the corpus of the algorithm). These sources of noise may lead the speech-to-text conversion approach to mis-transcribe certain words or phrases which directly relate to an action thus making direct correlation between the action and the relevant substring difficult. In fact, because the actions or offers are typically technical or obscure words, the transcripts are particularly noisy for the desired usage of determining correlations between the action and the relevant substring. For example, the plain-text representation for an action corresponding to a product “Samsung A20” may appear in the plain-text representation as “Samsung a twenty”, “Sam sung a twenty”, “Sam singer twin tea”, and the like. Consequently, a simple string-matching approach attempting to correlate the substring with the action would not sufficiently identify that an interaction referenced the product “Samsung A20” unless all possible permutations of the transcription of this term were known a priori.

Secondly, the direct correlation between a substring (such as the first substring 412) and an action (such as the relevant action 416) may not be known due to language discrepancies. These language discrepancies may be exacerbated by the speech-to-text conversion processes, particularly when the call is held in one language (e.g., French) but refers to certain words in another language (e.g., English). As such, a call may include a discussion of various actions which get mistranslated within the call transcript thus making the direct correlation between the relevant substrings and the actions difficult. For example, a text-to-speech process may know that a call being transcribed is in French and so will attempt to identify French words within the audio. This may lead to various nouns or proper nouns referring to specific actions (e.g., product names or offers) being incorrectly translated into French (e.g., the proper noun “Samsung” being transcribed as the French words “cinq cent”).

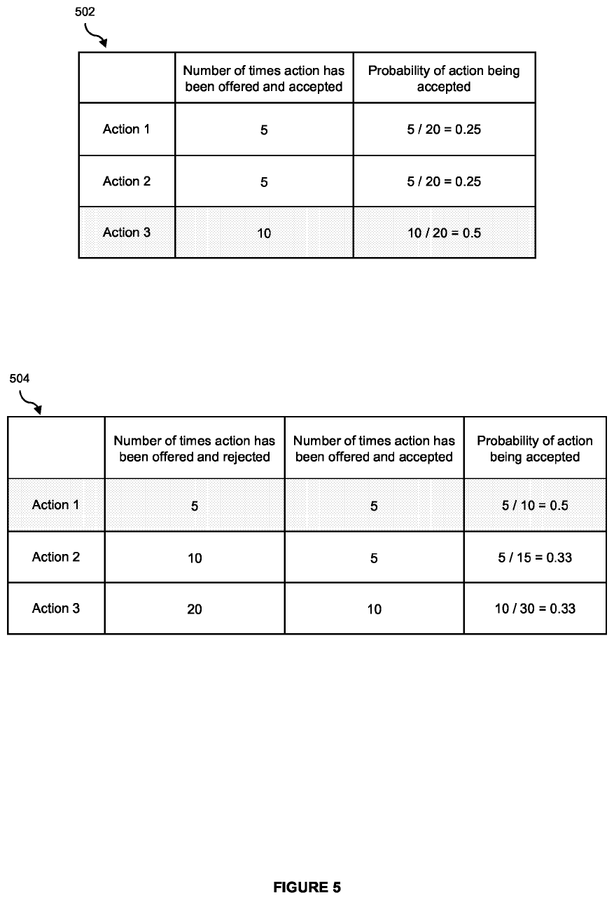

Additionally, the call transcript may comprise further actions which are not associated with an outcome but are nevertheless important to identify. As will be described in more detail in relation to FIG. 5, identifying these actions allows an improved pairing to be formed which, in turn, results in improved functioning and operation of the contact center system. Because these actions are not associated with an outcome, they are not known and may be referred to as hidden or latent actions. This is illustrated in the example transcript 410 which comprises a second substring 420 associated with a hidden relevant action 422. As neither the outcome of this action nor the exact form of the second substring 420 is known, the hidden relevant action 422 is not known.

Whilst the plurality of transcripts 402 comprises the first subset of transcripts 404 which are labelled i.e., each of the transcripts within the first subset of transcripts 404 have a known relevant action and an associated outcome—the second subset of transcripts 406 contains transcripts associated with hidden relevant actions. Identifying the second subset of transcripts 406 and using them to form a pairing model will help provide an improved pairing model.

As such, identifying both exposed and hidden actions from the first subset of transcripts 404 and the second subset of transcripts 406 helps improve the formation of the pairing model thereby improving the performance of the contact center system. This is illustrated in the tables shown in FIG. 5.

FIG. 5 illustrates action probabilities determined using two different approaches.

FIG. 5 shows a first table 502 associated with a first approach for determining action probabilities, and a second table 504 associated with a second approach for determining action probabilities. Both tables show the probability of an action being accepted for a particular agent and contact pairing. The action to recommend or take for the particular pairing is chosen from a set of three possible actions. For example, the tables may be associated with a unique agent identifier and a contact type identifier, or the tables may be associated with a unique agent identifier and a contact identifier.

The first table 502 shows action probabilities determined only from so called exposed actions—that is, actions which are identified from the transcript data because they have a known outcome (such as the relevant action-outcome pair 414 shown in FIG. 4). The second column of the first table 502 shows the number of times within the transcript data the different actions have been offered by the agent and accepted or taken by a contact. As such, the second column of the first table 502 lists the number of times that an action appears with an associated outcome within the transcript data. In one example of determining the probability of an action being accepted or taken, each value within the second column of the first table 502 is divided by the sum of that column. Using this approach, Action 3 is determined to be the most probable action. The present disclosure contemplates that there may be other methods of determining the probability of an action being accepted, however, no conventional techniques are able to examine action probabilities based on exposed or hidden actions.

The second table 504 shows action probabilities determined from both exposed and hidden actions, as described in the present disclosure. As described above, hidden actions are those actions appearing within the transcript data which are not associated with an outcome. Therefore, their presence within the transcript data is not identifiable from existing metadata alone (e.g., from label information accompanying transcripts). Hidden actions may correspond to an action which was offered but not accepted or taken. The second column of the second table 504 shows the number of times within the transcript data that each action was offered but not taken. To determine the probability of an action being accepted or taken, the ratio is calculated of the number of times the action has been offered and accepted to the total number of times the action has been offered (i.e., the number of times the action has been offered and rejected plus the number of times the action has been offered and accepted). Using this approach, although Action 3 has been accepted 10 times, it has been offered 30 times. As such, Action 3 has an acceptance rate of approximately 33%. In contrast, Action 1 has been accepted 5 times out of the 10 times it was offered thus leading to an acceptance rate of 50%.

Using the hidden or latent actions as well as the exposed actions to determine the probability of an action being taken therefore leads to a more accurate acceptance rate, or action probability, being determined. This in turn can lead to an improved and more effective pairing model which can improve the operations of a contact center system by avoiding inefficient pairings thereby reducing AHT, memory and bandwidth constraints, and inefficient resource allocation of the agents, contacts, and offers/actions. Therefore, improving the pairing model used by a contact assignment system may directly improve the operations and behavior of the contact assignment system. For a pairing model such as that described in relation to FIG. 3 above—where pairings are assigned on the basis of the agent, the contact type, and the probability of an action being taken—improving the identification of the probability of an action being taken may result in a better pairing between an agent and a contact as well as improving the identification of the most appropriate action to offer in the interaction. This may help reduce the time spent on an individual interaction therefore improving the AHT and/or may help provide efficient resource allocation of the agents, contacts, and offers/actions; all of which allow the contact center system to handle more interactions more efficiently.

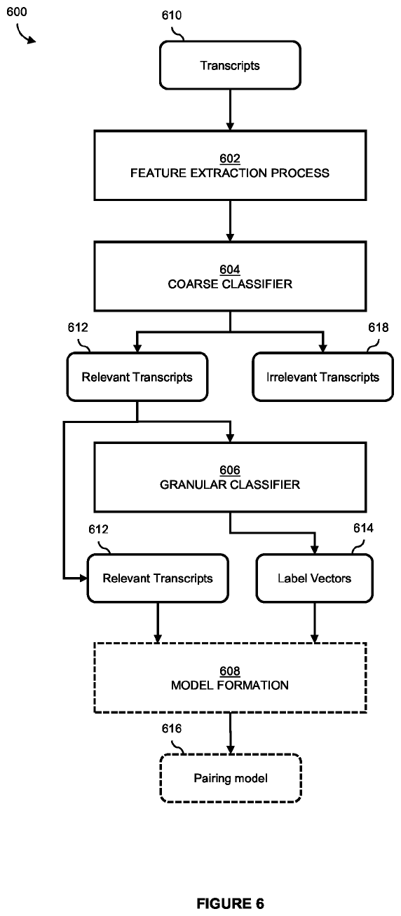

FIG. 6 shows a transcript labelling pipeline 600 for determining labels which can be used to form a pairing model. The pairing model may be used for decisioning behavioral pairing in a contact center system as described above.

The transcript labelling pipeline 600 comprises a feature extraction process 602, a coarse classifier 604, and a granular classifier 606. In some embodiments, the transcript labelling pipeline 600 further comprises a model formation step 608.

In general, the transcript labelling pipeline 600 receives a plurality of transcripts 610 as input and provides as output one or more relevant transcripts 612 and one or more label vectors 614 corresponding to the one or more relevant transcripts 612. In some embodiments, the model formation step 608 receives the one or more relevant transcripts 612 and the one or more label vectors 614 and generates a pairing model 616.

The plurality of transcripts 610 may be obtained from historical transcripts recorded at a contact center system (e.g., recorded and stored by the historical assignment module 190). The plurality of transcripts 610 may indicate the agents, the contacts and/or the contact types involved in each interaction. The plurality of transcripts 610 may be generated by processing audio recordings of the interactions through speech-to-text processing algorithms as are known in the art.

To identify the one or more relevant transcript 612 and the one or more label vectors 614, the transcript labelling pipeline 600 utilizes a two-step classification process. A coarse classifier 604 is used to filter one or more relevant transcripts 612 and one or more irrelevant transcripts 618 from the plurality of transcripts 610 without concern for which specific actions are present in the one or more relevant transcripts 612. A granular classifier 606 assigns a label vector to each transcript within the one or more relevant transcripts 612 to form the one or more label vectors 614. The label vector indicates which of the relevant actions are associated with the corresponding transcript.

Using a coarse classifier to filter the relevant transcripts avoids the need for the granular classifier to be trained on all possible actions which could lead to reduced predictive performance. By focusing the granular classifier on a smaller subset of (relevant) labels the predictive performance of the granular classifier is improved. Moreover, training the granular classifier on a smaller subset of possible actions leads to a more efficient model which can be trained more quickly and efficiently.

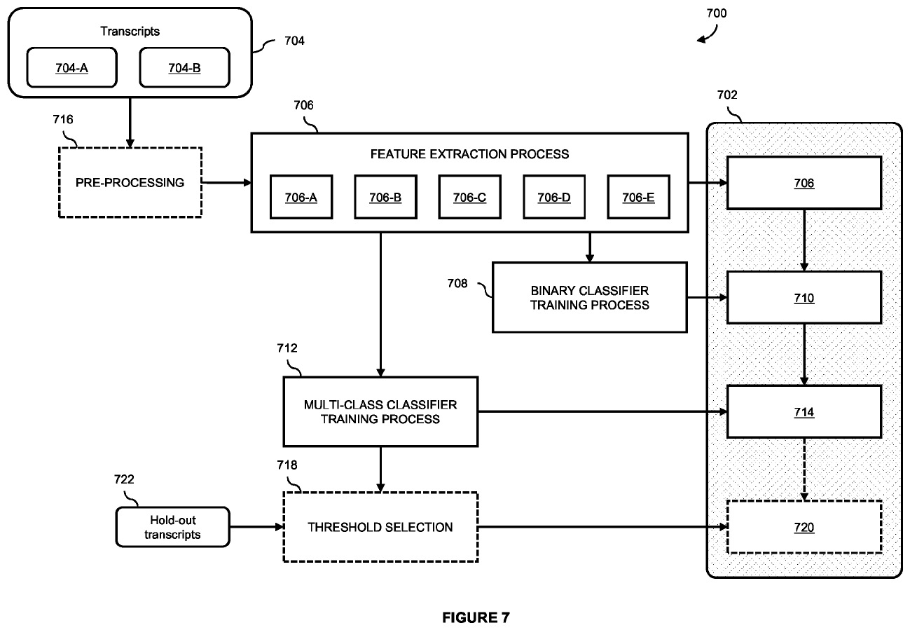

The feature extraction process 602 extracts natural language features which are used by the coarse classifier 604 and the granular classifier 606. As will be described in more detail below in relation to FIG. 7, the feature extraction process 602 receives a transcript (i.e., a plain-text representation of a call) and outputs a natural language feature vector representative of the transcript. In some embodiments, the plurality of transcripts 610 are pre-processed prior to using the feature extraction process 602. The pre-processing includes performing one or more pre-processing operations including text truncation, data augmentation, data clearing, and spell checking. The feature extraction process 602 extracts different representation levels of features from the plain-text representation. For example, the feature extraction process 602 may extract character-level features, word-level features, different contextual-level features which capture the context of words within a transcript, and transcript-level features. The different representation level features are then combined into a single natural language feature vector, or vectorized representation. The feature extraction process 602 is configurable such that the contribution of different representation levels to the natural language feature vector can be adjusted.

The present disclosure notes that conventional approaches to natural language processing applied to transcript data make heavy use of transformer-based models. However, training transformer-based models from scratch is both computationally intensive and resource heavy. To address this, conventional approaches may use transfer learning methods (e.g., fine-tuning a pre-trained transformer model) which allow a foundation model, such as a pre-trained transformer, to be adapted to the specific problem at hand without requiring a transformer to be trained from scratch. Although the use of transfer learning and foundation models can help reduce the computational and resource burden required to produce a trained model, they nevertheless suffer from several drawbacks. For example, transformer models may struggle with identifying rare and/or unknown words. Moreover, transformer models tend to perform well when the class size is reasonably small (e.g., binary) but tend to perform poorly with large class sizes (e.g., 100 or more classes). This can limit the effectiveness of the transformer models in many situations.

In contrast, the feature extraction process 602 of the present disclosure comprises an ensemble of feature extractors which help address the above limitations of purely transformer based approaches. The character-level and word-level feature extractors used by the feature extraction process 602 are vocabulary and language independent (i.e., unlike pre-trained transformer models, they are not limited to a single vocabulary) and provide outputs with improved discriminative power by penalizing high-frequency words within transcripts. Moreover, the feature extraction process 602 better adapts to the intricacies of the speech-to-text systems which generate the transcript data. For example, speech-to-text systems tend to repeat mis-transcriptions across transcripts and hence create a consistency with misspelled words. The feature extraction process 602 can adapt to this consistency because it is not reliant on a model trained on documents which do not exhibit such mis-transcriptions. The feature extraction process 602 of the present disclosure may therefore provide an improvement over transformer based approaches when processing noisy transcript data.

The coarse classifier 604 (which may alternately be referred to as a relevance classifier, binary classifier, filtering classifier, or filter) determines whether a transcript relates to relevant actions or irrelevant actions. More particularly, the coarse classifier 604 comprises a binary classifier which receives a natural language feature vector associated with a transcript and assigns a score to the feature vector indicative of whether the transcript relates to one or more relevant actions. Owing to the direct association between a transcript and a natural language feature vector extracted from that transcript, references below to a transcript in relation to the operation of the transcript labelling pipeline 600 will be understood by the skilled person as being references to a natural language feature vector associated with the transcript. In one embodiment, the score produced by the coarse classifier 604 is a probability of the transcript containing one or more substrings associated with one or more of the relevant actions. Alternatively, the score is a binary value which takes a value of “1” if the transcript is deemed relevant (i.e., it contains one or more substrings associated with one or more of the relevant actions) and “0” otherwise.

In one embodiment, the coarse classifier 604 comprises a trained binary extreme gradient boosting (XGBoost) model. Beneficially, the use of an XGBoost model may help provide a stronger classifier compared to the classification layer of transformer based models in terms of label size (i.e., number of relevant actions). The skilled person will, however, appreciate that other binary classification models may be used such as support vector machines (SVMs), decision trees, random forests, artificial neural networks, and the like.

If the coarse classifier 604 identifies a transcript as being an irrelevant transcript, e.g., as a result of the score produced by the coarse classifier 604 being below a predetermined threshold, then the transcript is not passed to the granular classifier 606 and forms part of the one or more irrelevant transcripts 618. In one embodiment, the transcript is assigned an empty label such that it is associated with none of the relevant labels. Conversely, if the coarse classifier 604 identifies a transcript as being a relevant transcript, e.g., as a result of the score produced by the coarse classifier 604 being equal to or above a predetermined threshold, then the transcript is passed to the granular classifier 606.

The granular classifier 606 (which may alternately be referred to as an action classifier, multi-label classifier, or assignment classifier) determines a label vector for a relevant transcript, where the label vector identifies which of the relevant actions are associated with the relevant transcript (i.e., which of the relevant actions are mentioned in the plain-text transcript of the relevant transcript). More particularly, the granular classifier 606 comprises a multi-class classifier which receives a natural language feature vector associated with a relevant transcript and assigns a score to the relevant transcript for each of the plurality of relevant actions. All of the assigned scores form a label vector for the relevant transcript. Therefore, the granular classifier 606 identifies relevant actions within a transcript even if the relevant action is not associated with an outcome (i.e., it is a hidden action). In some embodiments, the label vector may also indicate whether the action is known or hidden. For example, the label vector may comprise an action-outcome pair for each relevant action where a value of (1, 0) indicates that the relevant action is present in the transcript but hidden whereas a value of (1, 1) indicates that the relevant action is present in the transcript but known (i.e., it is associated with an outcome).

In one embodiment, the granular classifier 606 comprises a trained multi-class XGBoost model. The skilled person will appreciate that other multi-class classification models may be used such as support vector machines, decision trees, random forests, artificial neural networks, and the like.

In one embodiment, the label vector produced by the granular classifier 606 comprises a plurality of probabilities associated with the plurality of relevant actions. For example, for the three relevant actions, {“Samsung A20”, “Nokia 3210”, “Microsoft Surface Duo” } a label vector of [0.9, 0.1, 0.25] for a transcript would indicate a probability of 0.9 that the transcript mentions a Samsung A20, a probability of 0.1 that the transcript mentions a Nokia 3210, and a probability of 0.25 that the transcript mentions a Microsoft Surface Duo.

In one embodiment, the probabilities in the label vector are converted to binary values using a thresholding process. For example, if the transcript were reviewed by a human and manually labeled for each contact-agent interaction, determining the “ground truth” action(s) corresponding to each transcript would be a time- and resource-intensive operation. Therefore, the present disclosure contemplates a thresholding process (described in more detail below in relation to FIG. 7), which assigns a value of “1” to all probabilities which exceed or meet a threshold, and a value of “0” to all other probabilities. Manually-labeled data may be used in the disclosed transcript labelling pipeline 600; however, because using such manually-labeled data may result in low accuracy of the finally-labeled transcripts, the present disclosure contemplates separating any manually-labeled data into a first set for use in a thresholding process (e.g., process 720 as described below), and the remainder into a second set for use in training the model (e.g., as discussed below regarding semi-supervised learning).

The transcript labelling process—involving the feature extraction process 602, the coarse classifier 604, and the granular classifier 606—outputs the one or more relevant transcripts 612 identified by the coarse classifier 604 and the one or more label vectors 614 identified by the granular classifier. The one or more relevant transcripts 612 and the one or more label vectors 614 may then be used within a decisioning process of the contact center system.

In one embodiment, the one or more relevant transcripts 612 and the one or more label vectors 614 are used within a decisioning process of the contact center system by using the model formation step 608 to form a pairing model 616. The pairing model 616 may then be used within the decisioning process of the contact center system as described above.

The model formation step 608 receives the one or more relevant transcripts 612 and the one or more label vectors 614 and outputs the pairing model 616. In one embodiment, the model formation step 608 generates a new pairing model from the transcripts and labels provided. In an alternative embodiment, the model formation step 608 uses the transcripts and labels provided to update elements within an existing pairing model.

An element within the pairing model 616 may be determined by combining agent information (e.g., agent identity), contact or contact type information (e.g., the contact type identity), and action information (e.g., the probability of a relevant action being taken) from a transcript. Each transcript within the one or more relevant transcripts 612 is associated with an agent and a contact. This association may accompany a transcript in the form of metadata. The metadata may comprise information such as a unique identifier of the agent involved in the call to which the transcript relates, a unique contact identifier of the contact involved in the call to which the transcript relates, and a contact type indicative of a classification or grouping to which the contact relates. The agent and contact information contained in the metadata is used in conjunction with the one or more label vectors 614 to determine elements within the pairing model 616.

Specifically, for a pairing model comprising a first dimension corresponding to agents, a second dimension corresponding to contact types, and a third dimension corresponding to a probability of an action being taken, an element within the pairing model may represent a probability that a particular contact-agent pairing will result in a particular action being taken (as described above in relation to FIG. 3). Decisively, the probability is determined from both the exposed actions (i.e., the actions having a known outcome) and the hidden actions. The probability for an interaction between a first agent and a first contact type resulting in a first action being taken is calculated by identifying all the relevant transcripts involving the first agent and the first contact type and determining the number of times the first action has been taken and the total number of times the action has been offered (including times the first action has been taken and times the first action has been refused). The probability is then the ratio of the number of times the first action has been taken to the total number of times the action has been offered. As described above in relation to FIG. 4, utilizing both the exposed and hidden actions appearing within the transcript data provides an improved pairing model.

FIG. 7 shows a training process 700 for training a transcript labelling pipeline such as that shown in FIG. 6.

The training process 700 produces a transcript labeling pipeline 702 from a plurality of transcripts 704. The plurality of transcripts 704 comprises a first subset 704-A corresponding to relevant transcripts (i.e., transcripts which are known to relate to a relevant action because they have an associated relevant action-outcome pair) and a second subset 704-B corresponding to all other transcripts. The training process 700 comprises a feature extraction process 706, a binary classifier training process 708 which produces a coarse classifier 710, and a multi-class classifier training process 712 which generates a granular classifier 714. The feature extraction process comprises a character-level feature extraction model 706-A, a word-level feature extraction model 706-B, a first context-level feature extraction model 706-C, a second context-level feature extraction model 706-D, and a third context-level feature extraction model 706-E. The transcript labeling pipeline 702 is formed from the feature extraction process 706, the coarse classifier 710, and the granular classifier 714. In one embodiment, the training process 700 comprises a pre-processing step 716 and/or a threshold selection process 718. The threshold selection process 718 produces a thresholding operation 720 which may be included in the transcript labeling pipeline 702.

In general, the training process 700 produces the transcript labeling pipeline 702 from the plurality of transcripts 704 by using the feature extraction process 706 to extract a plurality of natural language feature vectors. The plurality of natural language feature vectors are then used in the binary classifier training process 708 to generate the coarse classifier 710 and the multi-class classifier training process 712 to generate the granular classifier 714. The feature extraction process 706, the coarse classifier 710, and the granular classifier 714 are then used to form the transcript labelling pipeline 702.

The plurality of transcripts 704 may be obtained from historical transcripts recorded at a contact center system over a period of time (e.g., recorded and stored by the historical assignment module 190). The plurality of transcripts 704 may indicate the agents, the contacts and/or the contact types involved in each interaction. The plurality of transcripts 704 may be generated by processing audio recordings of the interactions through speech-to-text processing algorithms as are known in the art.

The feature extraction process 706 is used to extract a plurality of natural language feature vectors from the plurality of transcripts 704. Particularly, the feature extraction process 706 produces a vectorized representation of a call transcript. In one embodiment, the plurality of transcripts 704 are pre-processed using a pre-processing step 716 prior to the feature extraction process 706. The pre-processing step 716 applies one or more pre-processing operations including text truncation, data augmentation, data cleaning, and spell checking. The pre-processing operations may be language specific such that the pre-processing operations performed depend on the language of the transcripts. For example, a French spell checking operation is performed if the transcripts are in French, whereas an English spell checking operation is performed if the transcripts are in English.

The feature extraction process 706 applies a multi-level feature extractor comprising a plurality of feature extraction models to a plain-text representation of a transcript to generate a corresponding plurality of intermediate natural language feature vector. The multi-level feature extractor is particularly effective at identifying and combining different linguistic features within a plain-text transcript which leads to an improved natural language representation of the plain-text transcript. Each of the feature extraction models extract a different representation level of natural language features from the transcript. As such, the feature extraction process 706 uses a character-level feature extraction model 706-A to extract character-level features from the plain-text representation, a word-level feature extraction model 706-B to extract word-level features from the plain-text representation, a first context-level feature extraction model 706-C, a second context-level feature extraction model 706-D, and a third context-level feature extraction model 706-E to extract context-based features from the plain-text representation. The feature extraction process 706 may further use a transcript-level feature extraction model (not shown) to extract transcript, or document, based features from the plain-text representation. For example, an average (e.g., mean) of the contextual embeddings can be used to determine a transcript-level representation. Further, character and word level TF-IDF scores give transcript level scorings (and even scorings among multiple transcripts).

Beneficially, the multi-level feature extractor produces a hierarchy of representations of a given transcript. This allows different levels of features to be extracted from the text thereby improving the performance of classifiers which use these features. Moreover, by linking the different feature extractors of the multi-level feature extractor to a different representation level (e.g., character, word, context, etc.), the configuration of the multi-level feature extractor is conceptually simpler thereby allowing heuristics to be developed to determine which configurations to use in various implementation settings.

In one embodiment, the character-level feature extraction model 706-A comprises a term frequency-inverse document frequency (TF-IDF) model of character n-grams. Beneficially, the use of character n-grams helps to capture accents and misspelling thereby improving the quality of the features extracted by the feature extraction process 706. In one example embodiment, unigrams, bigrams, and trigrams are extracted, and the TF-IDF model is limited to 70,000 features.

In one embodiment, the word-level feature extraction model 706-B comprises a TF-IDF model of word n-grams. In one example embodiment, unigrams, bigrams, and trigrams are extracted, and the TF-IDF model is limited to 70,000 features.

In one embodiment, the first context-level feature extraction model 706-C and the second context-level feature extraction model 706-D comprise a trained embedding model such as a word2vec vectorizer and a transformer-based model like BERT or RoBERTa-based CamemBERT (CBERT). In an example embodiment, word2vec is trained using a skipgram model using 200,000 training transcripts. The embedding dimension is set as 300 and an Adam optimizer with a negative sampling loss and a learning rate of 0.003 is used. In a further example embodiment, a CBERT model is fine-tuned on the 200,000 training transcripts using an Adam optimizer with a learning rate of 5×10⁻⁵ and ε=1×10⁻⁸. Beneficially, by training the context-level feature extraction models on specific speech-to-text data, a custom representation of words specific to speech-to-text output data may be generated. The use of such a custom representation may help improve the performance of the feature extraction process 706 when handling noisy transcript data.

In one embodiment, the third context-level feature extraction model 706-E comprises a model which generates a fuzzy embedding—i.e., a probabilistic class distribution for a given transcript. The fuzzy embedding may take the form of a vector having a dimensionality equal to the number of possible actions (or relevant actions) such that each value of the vector corresponds to a probability associated with one action (or relevant action). Here, a reference to classes may be understood as a reference to possible actions (or relevant actions). In general, the fuzzy embedding corresponds to the normalized frequencies of words in a transcript with respect to their class distribution across the training dataset. For example, consider the transcript text, “a repair of your phone may be appropriate”. In this example, there are two classes corresponding to two possible actions. For each word in the transcript text, a 2-dimensional embedding is created (i.e., an embedding equal to the number of possible actions). The 2-dimensional embedding corresponds to a class, or action, distribution. For example, the embedding for “a” in the transcript may be (0.5, 0.5) which corresponds to the normalized total number of occurrences of the word “a” in transcripts associated with each of the possible actions. This embedding vector may be understood as indicating that the word “a” occurs in the same number of transcripts for each possible action. Similarly, the 2-dimensional embedding for the word “repair” may be (0.25, 0.75) which indicates that the word “repair” is three times more likely to appear in transcripts related to the second possible action than in transcripts associated with the first possible action. After the embeddings are generated for all words in the transcript, an average of the embeddings is calculated. This average corresponds to the fuzzy embedding for the transcript. The fuzzy embedding context-level feature extraction model may therefore be considered a type of supervised feature extraction approach as it relies on the action-based distribution of words within the training data.

The plurality of feature extraction models in the multi-level feature extractor are applied to a plain-text representation of a transcript to generate a plurality of intermediate language vectors. The feature vector produced by each feature extraction model is weighted according to a weighting factor, vᵢ. Let t represent a transcript with n many words, i.e., t=[w₁, . . . , wₙ]. The vectorized representation of the transcript is then created by

V(t)=v₁*f₁(t)⊕ . . . ⊕vₘ*fₘ(t)

Where f₂, . . . , fₘ correspond to each of the feature extraction models within the multi-level feature extractor. The weightings, v=(v₁, . . . , vₘ), determine the contribution of the corresponding feature extraction model to the vectorized representation. As such, by modifying the weightings, the vectorized representation of the transcript can be fine-tuned for different contexts. Beneficially, this allows the feature extraction process 706 to be efficiently implemented across different contexts (e.g., languages, domains, task settings, etc.). In one example embodiment, each weight is binary valued such that vᵢ∈{0,1}. Alternatively, each weight is real valued such that vᵢ∈[0,1].

In embodiments where the character-level feature extraction model 706-A comprises a TF-IDF model of character n-grams, tf-idf_{c}(t), the word-level feature extraction model 706-B comprises a TF-IDF model of word n-grams, tf-idf_{w}(t), the first context-level feature extraction model 706-C comprises a trained word2vec vectorizer, W2V(w), the second context-level feature extraction model 706-D comprises a fine-tuned CBERT model, BRT(w), and the third context-level feature extraction model 706-E comprises a fuzzy embedding model, fuzzy(w), the vectorized representation of the transcript, t, is created by:

$$V ( t ) = {v}_{1} * tf - i d {f}_{c} ( t ) ⊕ {v}_{2} * tf - {idf}_{w} ( t ) ⊕ {v}_{3} * \frac{1}{n} ( {\sum }_{i}^{n} B R T ( {w}_{i} ) ) ⊕ {v}_{4} * \frac{1}{n} ( {\sum }_{i}^{n} W 2 V ( {w}_{i} ) ) ⊕ {v}_{5} * \frac{1}{n} ( {\sum }_{i}^{′ ι} fuzzy ( {w}_{i} ) )$$

Here, ⊕ represents the concatenation operation. In embodiments, the average of the embeddings produced by the first context-level feature extraction model 706-C, the second context-level feature extraction model 706-D, and the third context-level feature extraction model 706-D, or a combination thereof, are used to generate a transcript-level feature which may be concatenated to the other features as part of the vectorized representation described above.

After the vectorized representation of the plurality of transcripts 704 are extracted, they are output from the feature extraction process 706 as a plurality of natural language feature vectors for use in generating the coarse classifier 710 and the granular classifier 714.

The coarse classifier 710 is generated in the binary classifier training process 708 by training a binary classifier using the plurality of natural language feature vectors and an indictor vector. In one embodiment, the binary classifier is a binary extreme gradient boosting (XGBoost) model. The XGBoost model is trained on the plurality of natural language feature vectors and the indicator vector using a log-loss loss function, a learning rate of 0.1, and 200 estimators. The skilled person will appreciate that other binary classification models may be used such as support vector machines (SVMs), decision trees, random forests, artificial neural networks, and the like. The indicator vector identifies the first subset 704-A (known to relate to a relevant action) from within the plurality of transcripts 704. As such, the indicator vector may take the form of a binary vector indicating a true or false value for each transcript within the plurality of transcripts (where the true or false value indicates whether the corresponding transcript is known to relate to a relevant action). The indicator vector therefore becomes the target vector upon which the binary classifier is trained.

In many situations, the number of “labeled” transcripts (i.e., those in the first subset 704-A known to relate to a relevant action) is far fewer than the number of unlabeled transcripts. In some instances, the ratio of such unlabeled transcripts are approximately 90% of all transcripts. To address this issue, in some embodiments, the binary classifier is trained using a semi-supervised training method. Semi-supervised learning is a learning method that uses large amounts of unlabeled data together with the labeled data to train the final model. The insight behind semi-supervised learning techniques is that relevant information can be learnt from both the labeled and the unlabeled data. In one embodiment, self-training is used to perform semi-supervised training. In self-training, the binary classifier is first trained on the natural language feature vectors associated with the transcripts within the first subset 704-A. After observing the predicted probabilities produced by the binary classifier, the indicator vector is updated to include the most confidently labeled natural language feature vectors (i.e., those with the highest predicted probability) from within the plurality of natural language feature vectors. The binary classifier is re-trained, and the procedure is repeated until the labeling is stable or stabilizes within a predetermined threshold.

The coarse classifier 710, once trained, assigns a relevance label of “1” to natural language feature vectors associated with transcripts which are predicted to be relevant (i.e., they are predicted to relate to a relevant action), and a relevance label of “0” to natural language feature vectors associated with transcripts which are predicted to be irrelevant.

The granular classifier 714 is generated in the multi-class classifier training process 712 by training a multi-class classifier using the first subset 704-A and an action vector associated with the first subset 704-A. In one embodiment, the multi-class classifier is a multi-class XGBoost model. The XGBoost model is trained on the first subset 704-A and the action vector using a log-loss loss function, a learning rate of 0.1, and 200 estimators. The skilled person will appreciate that other multi-class classification models may be used such as support vector machines, decision trees, random forests, artificial neural networks, and the like. The action vector comprises, for each of the transcripts within the first subset 704-A, a relevant action known to be associated with the corresponding transcript within the first subset 704-A. As such, the action vector comprises a relevant action for each relevant transcript as described in relation to the relevant action 516 of the relevant action-outcome pair 514 of FIG. 5.

For example, consider an action vector, L, associated with a transcript, t. The action vector L comprises k elements corresponding to the k possible relevant actions with the plurality of relevant actions, K. A value of 1 at position Lᵢ indicates that the i-th relevant action of K is associated with the transcript t (e.g., the i-th relevant action is mentioned or offered in the transcript t). The multi-class classifier is trained to predict a label vector, \hat{L}, for a feature vector, x, associated with a transcript, t, where the i-th value in \hat{L} indicates whether t is predicted to be associated with the i-th relevant action of K. In one embodiment, the elements of \hat{L} are binary valued such that \hat{L}. Alternatively, the elements of \hat{L} are real-valued and indicate a score or probability for each relevant action.

In embodiments where the elements of \hat{L} are real-valued scores or probabilities, a thresholding operation may be performed to convert the elements of \hat{L} to binary values. In such embodiments, the training process 700 comprises a threshold selection process 718 which produces a thresholding operation 720. The thresholding operation may then be included as part of the transcript labeling pipeline 702. The threshold selection process 718 uses the granular classifier 714 on a hold-out set 722 of manually annotated transcripts. Each transcript within the hold-out set 722 was assigned a label indicating one or more relevant actions associated with the transcript. In one example embodiment, the hold-out set 722 comprises approximately 200 manually labeled transcripts. A search over possible threshold values is performed (e.g., using a grid search method) and for each iteration of the search, a test threshold value is selected and a random subset of the hold-out set 722 is selected as a training set (e.g., 50%, 75%, 90%, etc. of the hold-out set 722). The granular classifier 714 is applied to each natural language feature vector in the random subset and the test threshold value is applied to the resulting label vectors to generate binary valued label vectors. The accuracy of the test threshold value is determined using

$$accuracy = \frac{abs ( A ⋂ B )}{max ( abs ( A ) , abs ( A ) )}$$

Where A is the set of relevant actions in the manually labeled vector for a transcript t, and B is the set of relevant actions generated from the prediction produced by the granular classifier 714 for t with the test threshold value applied. The accuracy is recorded for each threshold value within the search and the threshold value with the highest recorded accuracy is chosen for the thresholding operation 720. The thresholding operation 720 therefore converts a real-valued label vector produced by the granular classifier 714 to a binary-valued label vector by assigning a value of 1 to all values within the real-valued label vector which are greater than or equal to the chosen threshold value.

The transcript labeling pipeline 702 is then formed from the feature extraction process 706, the coarse classifier 710, the granular classifier 714, and optionally the thresholding operation 720. The transcript labeling pipeline 702 in use operates as described in relation to the operations of FIG. 6.

As such, the transcript labeling pipeline 702 may be used to label a set of transcripts for use within various machine learning processes in a contact center system. In one embodiment, the transcript labeling pipeline 702 is used to process a set of transcripts, to identify exposed and hidden actions, which are then used to form a pairing model, as described above in relation to FIGS. 3 and 6, which can be used in contact assignment system to efficiently assign contacts and agents.

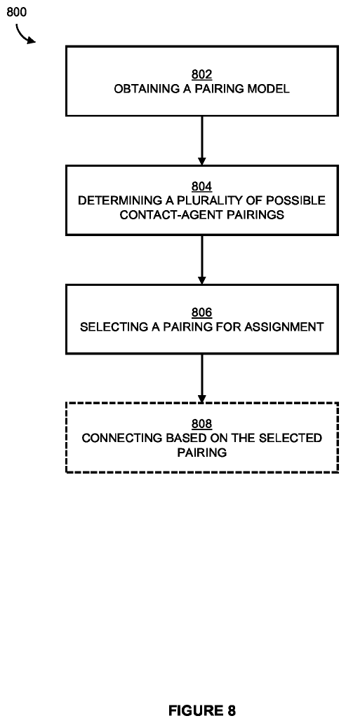

FIG. 8 shows a method 800 for decisioning behavioral pairing in a contact center system according to an aspect of the present disclosure. In one embodiment, the method 800 is performed by a pairing module such as the behavioral pairing module 140 of FIG. 1A or the contact assignment strategy module 180 of FIG. 1B.

The method 800 comprises the steps of obtaining 802 a pairing model, determining 804 a plurality of possible contact-agent pairings, and selecting 806 a pairing model for assignment. The method 800 optionally comprises the step of connecting 808 based on the selected pairing model.

The method 800 therefore causes the contact center system to operate in a new and improved manner. Identifying the most relevant contact-agent pairing, and the most likely action to be accepted during an interaction involving that pairing, leads to an improved contact center system because contacts are served more efficiently, for example by reducing AHT and/or more efficient contact, agent, and offer/action resource allocation, thereby allowing the contact center system to process more interactions more efficiently.

At the obtaining 802 step of the method 800, a pairing model comprising a plurality of elements is obtained. The pairing model is determined from transcript data related to calls within the contact center system involving a plurality of agents and a plurality of contact types (as described in relation to FIGS. 3-6). An element of the plurality of elements is indicative of a probability that a contact-agent pairing will be associated with an action of a plurality of possible actions being taken. The probability is determined from instances of offered and taken actions appearing within the transcript data and instances of offered and refused actions appearing within the transcript data.

At the determining 804 step of the method 800, a plurality of possible contact-agent pairings are determined from among a plurality of contacts waiting for assignment and at least one agent available for assignment. The plurality of possible contact-agent pairings is determined from an agent dimension and a contact type dimension of the pairing model (e.g., from the agent dimension 302 and the contact type dimension 304 as shown in the pairing model 300 of FIG. 3).

At the selecting 806 step of the method 800 a first contact-agent pairing is selected for assignment in the contact center system using the contact type dimension and an action probability dimension of the pairing model. The first contact-agent pairing is selected to increase a likelihood of the contact-agent pairing resulting in an action being offered and taken. That is, the first contact-agent pairing is selected from the plurality of possible contact-agent pairings based on a plurality of possible action probabilities determined from an action probability dimension of the pairing model. In one embodiment, the action probability dimension relates to a plurality of potential offers to be offered by the plurality of agents.

In some embodiments, the first contact-agent pairing is selected based on the action probability dimension of the pairing model and a resource availability. For example, in embodiments where the actions correspond to offers available for agents to present to contacts, a contact center may have a limited availability for each offer (e.g., there are only 100 offers available for product A, and there are only 100 offers available for product B). Considering two contact types, CT1 and CT2, both CT1 and CT2 accept offer A, but only CT2 accepts offer B. For this example, consider that during a fixed time, 200 contacts arrive, 120 of which are of type CT1, and 80 of which are type CT2, both of which arrive randomly at the contact center.

Under a traditional system which does not optimize resource allocation, an agent may have determined that all contacts accept offer A. Consequently, the agent does not suggest offer B until there are no further A offers. Given this, it would be expected that, during the fixed time and under a conventional system, only 140 contacts of the 200 contacts could be serviced. That is, the agent will suggest offer A to the first 100 contacts, 60 of which would be CT1 and 40 of which would be CT2. For the remaining 100 contacts, the agent will suggest offer B, and only the remaining CT2 contacts would accept (e.g., 40 remaining CT2 contacts).

By contrast, if, according to the presently described invention, by properly deciding which contact types should be offered which products or offers, the service can be increased so that 180 contacts are serviced. That is, the present invention will determine that the agent should suggest offer B to all 80 CT2 contacts, and will suggest offer A to the first 100 CT1 contacts.

Therefore, the present disclosure always provides better resource allocation than conventional systems. Particularly, method 800 results in the contact center system operating in a new way. The pairings determined from the pairing model cause one or more of the switches in the contact center system to route contacts to agents. As described above, the method 800 optimizes these connections to improve contact handling and reduce factors affecting contact center operation, such as AHT.

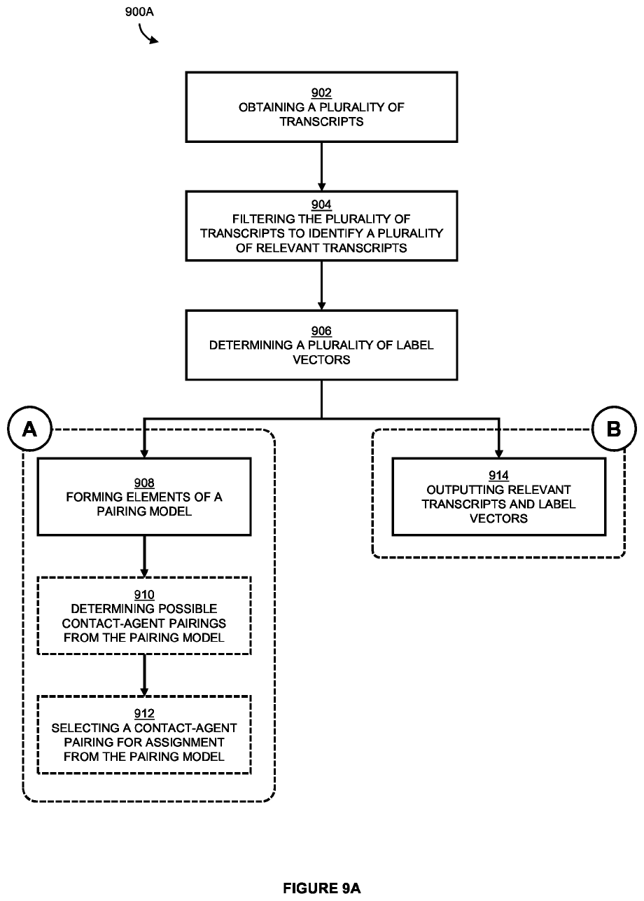

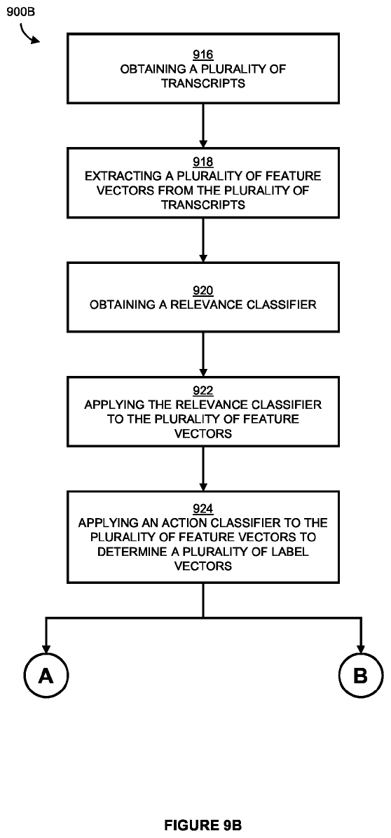

FIG. 9A shows a method 900A for determining label vectors from relevant transcripts according to an aspect of the present disclosure. As such, the method 900A corresponds to the transcript labeling pipeline 600 shown in FIG. 6.

The method 900A comprises the steps of obtaining 902 a plurality of transcripts, filtering 904 the plurality of transcripts to identify a plurality of relevant transcripts, and determining 906 a plurality of label vectors. In one embodiment, the plurality of label vectors are used for forming a pairing model for decisioning behavioral pairing in a contact center system such that the method 900A comprises the step of forming 908 elements of a pairing model, and optionally comprises the steps of determining 910 possible contact-agent pairings from the pairing model and selecting 912 a contact-agent pairing for assignment from the pairing model. In another embodiment, the method 900A further comprises, in addition to or instead of the step of forming 908, the step of outputting 914 the relevant transcripts and label vectors.

At the obtaining 902 step of the method 900A, a plurality of transcripts (e.g., the plurality of transcripts 610 in FIG. 6) are obtained. Each transcript comprises a plain-text representation of a call held within the contact center system. The plain text representation of each transcript has at least one substring associated with at least one action of a predetermined plurality of actions. The predetermined plurality of actions include a plurality of relevant actions and one or more irrelevant actions. In one embodiment, the plurality of actions correspond to a plurality of offers and the plurality of relevant actions correspond to a plurality of relevant offers.

At the filtering 904 step of the method 900A, a relevance classifier (or coarse classifier; e.g., the coarse classifier 604 in FIG. 6) is used to filter the plurality of transcripts to identify a plurality of relevant transcripts. This operation is described in more detail in relation to FIGS. 4-6 above. Each of the plurality of relevant transcripts comprises a substring associated with one of the plurality of relevant actions. In one embodiment, the relevance classifier comprises a binary classifier, such as a binary extreme gradient boosting classifier, trained on a training set of transcripts. Each transcript within the training set of transcripts is known to have at least one substring associated with at least one action of the predetermined plurality of actions.

At the determining 906 step of the method 900A, an action classifier (or granular classifier; e.g., the granular classifier 606 in FIG. 6) is used to determine a plurality of label vectors for the plurality of relevant transcripts. A label vector within the plurality of label vectors is associated with a relevant transcript and indicates which of the plurality of relevant actions are associated with the relevant transcript.

In one embodiment, the action classifier comprises a multi class classifier, such as a multi-class extreme gradient boosting classifier, trained on a training set of transcripts. Each transcript within the training set of transcripts is known to have at least one substring associated with at least one relevant action of the plurality of relevant actions.

In one embodiment, the method 900A comprises the forming step 908 (e.g., model formation 606 in FIG. 6). At the forming 908, a plurality of elements of a pairing model (e.g., the pairing model 616 in FIG. 6) are formed based on one or more agents associated with the plurality of relevant transcripts, one or more contact types associated with the plurality of relevant transcripts, and the plurality of label vectors. An element in the plurality of elements is indicative of a probability that a contact-agent pairing will be associated with an action being taken.

In embodiments including the forming step 908, the method 900A may comprise the step of determining 910 and the step of selecting 912. At the step of determining 910, a plurality of possible contact-agent pairings are determined from among a plurality of contacts waiting for assignment and at least one agent available for assignment. The plurality of possible contact-agent pairings is determined from a first dimension of the pairing model and a second dimension of the pairing model. The first dimension may be an agent dimension associated with a plurality of agents of the contact center system (e.g., the agent dimension 302 of the pairing model 300 in FIG. 3). The second dimension may be a contact dimension associated with a plurality of contact types of the contact center system (e.g., the contact type dimension 304 of the pairing model 300 in FIG. 3). The third dimension may be an action probability dimension associated with the predetermined plurality of actions (e.g., the action probability dimension 306 of the pairing model 300 in FIG. 3). In one example embodiment, the plurality of actions correspond to a plurality of offers to be offered by a plurality of agents of the contact center system.

At the step of selecting 912, a first contact-agent pairing is selected for assignment in the contact center system. The first contact-agent pairing is selected from the plurality of possible contact-agent pairings based on a third dimension of the pairing model. A switch of the contact center system may then be instructed to form the connection within the contact center system which affects the first contact-agent pairing.

In a further embodiment, the method 900A further comprises, in addition to or instead of the step of forming 908, the step of outputting 914 the relevant transcripts and label vectors. The relevant transcripts and label vectors may be output for storage at the contact center system or be used for further analysis.

FIG. 9B shows a further method 900B for determining label vectors from relevant transcripts according to an aspect of the present disclosure. As such, the method 900A corresponds to the transcript labeling pipeline 600 shown in FIG. 6.

The method 900B comprises the steps of obtaining 916 a plurality of transcripts, extracting 918 a plurality of feature vectors from the plurality of transcripts, obtaining 920 a relevance classifier, applying 922 the relevance classifier to the plurality of feature vectors, and applying 924 the action classifier to the plurality of feature vectors to determine a plurality of label vectors. In one embodiment, the plurality of label vectors are used for forming a pairing model for decisioning behavioral pairing in a contact center system such that the method 900B comprises the step of forming 908, as described in relation to method 900A of FIG. 9A, and optionally comprises the steps of determining 910 and selecting 912 as described in relation to method 900A of FIG. 9A. In another embodiment, the method 900B further comprises, in addition to or instead of the step of forming 908, the step of outputting 914 as described in relation to the method 900A of FIG. 9A.

At the obtaining 916 step of the method 900B, a plurality of transcripts are obtained (e.g., the plurality of transcripts 610 in FIG. 6). Each transcript of the plurality of transcripts comprises a plain-text representation of a call involving an agent of the contact center system and a contact having a contact type. The plain text representation has at least one substring associated with at least one action of a predetermined plurality of actions. The predetermined plurality of actions include a plurality of relevant actions and one or more irrelevant actions. In one embodiment, the plurality of actions correspond to a plurality of offers and the plurality of relevant actions correspond to a plurality of relevant offers.

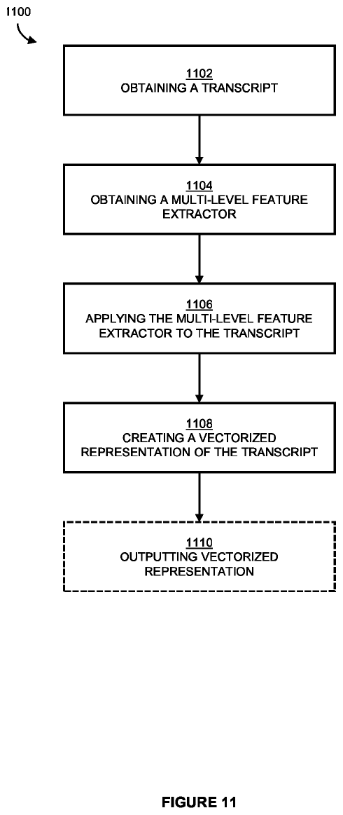

At the extracting 918 step of the method 900B, a plurality of natural language feature vectors are extracted from the plurality of transcripts using a feature extraction process (e.g., the feature extraction process 602 shown in FIG. 6) described in more detail in relation to FIG. 11 below. In one embodiment, the method 900B further comprises, prior to the extracting 918 step, applying one or more pre-processing operations to the plurality of transcripts. The one or more pre-processing operations include one or more of a text truncation, a data augmentation, a data cleaning, and a spell checking.

At the obtaining 920 step of the method 900B, a relevance classifier is obtained (e.g., the coarse classifier 604 in FIG. 6). The relevance classifier assigns a relevance score to a natural language feature vector. The relevance score is indicative of a probability that a transcript associated with the natural language feature vector is associated with one or more of the plurality of relevant actions.

At the applying 922 step of the method 900B, the relevance classifier is applied to the plurality of natural language feature vectors (extracted at the extracting 918 step) to identify a plurality of relevant natural language feature vectors from the plurality of natural language feature vectors. The plurality of relevant natural language feature vectors are associated with a plurality of relevant transcripts of the plurality of transcripts which are related to the plurality of relevant actions. In one embodiment, the relevance classifier comprises a binary classifier, such as a binary extreme gradient boosting classifier, trained on a training set of transcripts. Each transcript within the training set of transcripts is known to have at least one substring associated with at least one action of the predetermined plurality of actions.

At the applying 924 step of the method 900B, an action classifier (e.g., the granular classifier 606) is applied to the plurality of relevant natural language feature vectors to determine a plurality of label vectors. A label vector of the plurality of label vectors indicates which of the plurality of relevant actions are associated with a transcript associated with the label vector. In one embodiment, the action classifier comprises a multi class classifier, such as a multi-class extreme gradient boosting classifier, trained on a training set of transcripts. Each transcript within the training set of transcripts is known to have at least one substring associated with at least one relevant action of the plurality of relevant actions.

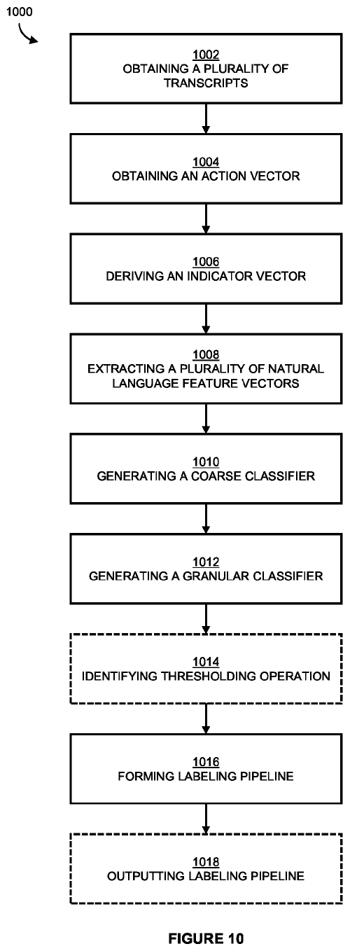

FIG. 10 shows a method 1000 for training a transcript labeling pipeline (such as that used in the method 900A of FIG. 9A and the method 900B of FIG. 9B) according to an aspect of the present disclosure. As such, the method 1000 corresponds to the training process 700 shown in FIG. 7.

The method 1000 comprises the steps of obtaining 1002 a plurality of transcripts, obtaining 1004 an action vector, and deriving 1006 an indicator vector. The method 1000 further comprises the steps of extracting 1008 a plurality of natural language feature vectors, generating 1010 a coarse classifier, generating 1012 a granular classifier, and forming 1016 a labeling pipeline. Optionally, the method 1000 comprises the steps of identifying 1014 a thresholding operation and outputting 1018 the transcript labeling pipeline.

At the obtaining 1002 step of the method 1000, a plurality of transcripts are obtained (e.g., the plurality of transcripts 704 in FIG. 7). Each transcript of the plurality of transcripts comprises a plain-text representation of a call held between an agent and a contact. The plain-text representation has at least one substring associated with at least one action of a predetermined plurality of actions; however the association may not be labeled. For example, and as described otherwise herein, the substring ‘cinq cent A20’ may be associated with an action ‘Samsung A20’, but the association may not be labeled, such that the association is hidden or latent. The predetermined plurality of actions includes a plurality of relevant actions and one or more irrelevant actions. In one embodiment, the plurality of actions correspond to a plurality of offers and the plurality of relevant actions correspond to a plurality of relevant offers.

At the obtaining 1004 step of the method 1000, an action vector associated with a subset of the plurality of transcripts (e.g., the first subset 704-A) is obtained. The action vector comprises, for a transcript within the subset of the plurality of transcripts, an action of the plurality of relevant actions. The action is associated with a substring within the plain-text representation of the transcript.

At the deriving 1006 step of the method 1000, an indicator vector is derived from the action vector. The indicator vector identifies the subset of the plurality of transcripts within the plurality of transcripts.

At the extracting 1008 step of the method 1000, a plurality of natural language feature vectors are extracted from the plurality of transcripts using a feature extraction process (e.g., the feature extraction process 706) as described in more detail in relation to FIG. 11 below. The plurality of natural language feature vectors comprises a subset of natural language feature vectors corresponding to the subset of the plurality of transcripts. Optionally, the method 1000 further comprises, prior to the step of extracting 1008, applying one or more pre-processing operations to the plurality of transcripts. The one or more pre-processing operations include one or more of a text truncation, a data augmentation, a data cleaning, and a spell checking.

At the generating 1010 step of the method 1000, a coarse classifier (e.g., the coarse classifier 710 in FIG. 7) is generated by training (e.g., using the binary classifier training process 708 of FIG. 7) a binary classifier using the plurality of natural language feature vectors and the indicator vector. The coarse classifier estimates, for a natural language feature vector associated with a transcript, a probability that the transcript is related to the plurality of relevant actions. In one embodiment, the coarse classifier comprises a binary extreme gradient boosting classifier. In one embodiment, the binary classifier is trained using a semi-supervised training method. The semi-supervised training method may comprise repeatedly training the binary classifier on the plurality of natural language feature vectors and the indicator vector using a self-training approach.

At the generating 1012 step of the method 1000, a granular classifier (e.g., the granular classifier 714 in FIG. 7) is generated by training (e.g., using the multi-class classifier training process 712 in FIG. 7) a multi-class classifier using the subset of natural language feature vectors and the action vector. The granular classifier determines, for the natural language feature vector associated with the transcript, a label vector having a plurality of label values associated with the plurality of relevant actions. Each label value of the plurality of label values indicating whether the transcript comprises a substring associated with a relevant action of the plurality relevant actions. In one embodiment, the multi-class classifier comprises a multi-class gradient boosting classifier.

At the optional identifying 1014 step of the method 1000, a thresholding operation (e.g., the thresholding operation 720 in FIG. 7) is identified (e.g., using the threshold selection process 718 in FIG. 7) to convert the label vector to a binary-valued label vector. The thresholding operation is included as part of the transcript labeling pipeline. In one embodiment, the thresholding operation is based on a threshold identified using a grid search and a hold-out set of transcripts (e.g., the hold-out set 722 in FIG. 7) known to be associated with the plurality of relevant actions. In such embodiments, each label value of the plurality of label values are binary valued.

At the forming 1016 step of the method 1000, the transcript labeling pipeline (e.g., the transcript labeling pipeline 702 in FIG. 7) is formed from the feature extraction process (e.g., the feature extraction process 706 in FIG. 7), the coarse classifier (e.g., the coarse classifier 710 in FIG. 7), the granular classifier (e.g., the granular classifier 714 in FIG. 7), and optionally the thresholding operation (e.g., the thresholding operation 720 in FIG. 7). The formed transcript labeling pipeline receives a transcript and passes the transcript to the feature extraction process to generate a vectorized representation. The vectorized representation is passed to the coarse classifier to determine the relevance of the transcript. The vectorized representation is passed to the granular classifier when an estimated probability determined by the coarse classifier for the natural language feature vector exceeds, or meets, a predetermined threshold. It the estimated probability does not exceed the predetermined threshold, then the transcript labeling pipeline may provide an empty label vector as output.

At the optional outputting 1018 step of the method 1000, the transcript labeling pipeline is output for use within a contact center system (e.g., as described in relation to FIGS. 6 and 8-9).

FIG. 11 shows a method 1100 for automatic vectorization of plain-text transcript data according to an aspect of the present disclosure. The method 1000 may be used as part of the extracting 916 step of method 900B and/or the extracting 1008 step of FIG. 10.

The method 1100 comprises the steps of obtaining 1102 a transcript, obtaining 1104 a multi-level feature extractor, applying 1106 the multi-level feature extractor to the transcript, and creating 1108 a vectorized representation of the transcript. The method 1100 optionally comprises the step of outputting 1110 the vectorized representation.

At the obtaining 1102 step of the method 1100, a transcript comprising a plain-text representation of a call held between an agent and a contact is obtained.

At the obtaining 1104 step of the method 1100, a multi-level feature extractor is obtained for extracting a plurality of natural language feature vectors from an input transcript. The multi-level feature extractor comprises a plurality of feature extraction models (e.g., the feature extraction models 706-A, 706-B, 706-C, 706-D in FIG. 7) each of which produces a natural language feature vector of the plurality of natural language feature vectors. Each multi-level feature extractor extracts a different representation level of natural language features from within the transcript. In one embodiment the plurality of feature extraction models include two or more of a character-level feature extraction model (e.g., the character-level feature extraction model 706-A in FIG. 7); a word-level feature extraction model (e.g., the word-level feature extraction model 706-B in FIG. 7); and at least one contextual-level feature extraction model (e.g., the first context-level feature extraction model 706-C or the second context-level feature extraction model 706-D in FIG. 7). The character-level feature extraction model may comprise a term frequency-inverse document frequency model of character n-grams. The word-level feature extraction model may comprise a character level term frequency-inverse document frequency model of word n-grams. The at least one contextual-level feature extraction model may comprise a trained embedding model such as a trained word2vec model or a transformer model such as BERT or CBERT.

At the applying 1106 step of the method 1100, the multi-level feature extractor is applied to the transcript thereby generating a plurality of intermediate natural language vectors.

At the creating 1108 step of the method 1100, a vectorized representation of the transcript is created by weighting each intermediate natural language vector of the plurality of intermediate natural language vectors according to a corresponding weighting factor of a plurality of weighting factors. Each weighting factor of the plurality of weighting factors determines a contribution of a corresponding intermediate natural language vector to the vectorized representation. The plurality of weighting factors may be obtained prior to the step of creating the vectorized representation. In one embodiment, creating the vectorized representation comprises concatenating the plurality of intermediate natural language vectors weighted according to the plurality of weighting factors. Alternatively, an average value for each of the plurality of intermediate vectors are concatenated to create the vectorized representation. The plurality of weighting factors may be binary valued.

At the optional outputting 1110 step of the method 1100, the vectorized representation of the transcript is output for use in a machine learning pipeline (e.g., as described in relation to FIGS. 6-7, and 9-10).

### EXAMPLE RESULTS

The following results are provided by way of example only and are not intended to limit the scope of the present disclosure in any way. The effectiveness of the techniques of the present disclosure are outlined above in relation to the processing of natural language documents for transcript labeling and forming a pairing model for decisioning behavioral pairing in a contact center system.

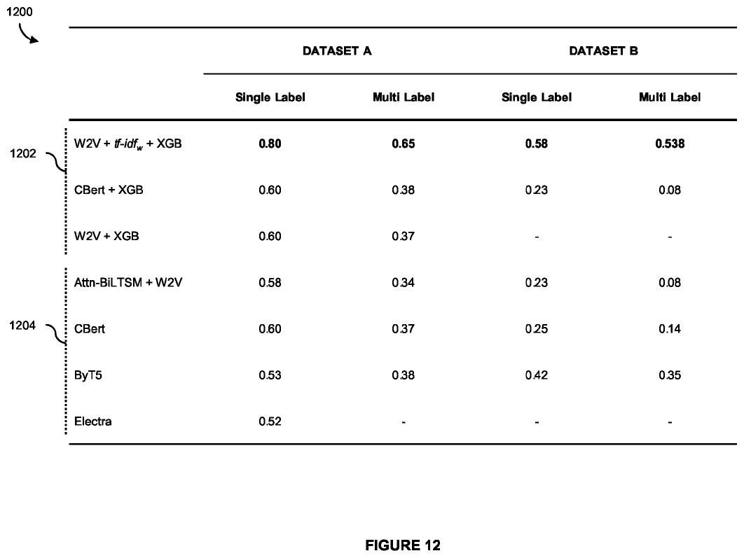

FIG. 12 shows a results table 1200 of various methods applied to two noisy transcript datasets.

The results table 1200 shows transcript labelling results for two datasets—Dataset A and Dataset B—for approaches according to the present disclosure 1202 and baseline approaches 1204. The approaches according to the present disclosure 1202 correspond to XGBoost based coarse and granular classifiers with different feature extractors (combinations of a word-level feature extractor and two different context level feature extractors). The baseline approaches 1204 correspond to a BiLS™ with Attention and Word2Vec, CBert, ByT5, and Electra.

Dataset A corresponds to a set of 48,657 French transcripts having 6 possible actions (i.e., 6 outcomes, labels, or classes). The transcripts were obtained by applying a third-party speech-to-text system to 48,657 recorded contact center interactions. The 6 possible actions correspond to 6 possible contracts which could have been offered by an agent during an interaction. The dataset was used with 0.2 train-test splits, 503 manually labelled transcripts, 251 transcripts used for determining the threshold, and 252 transcripts used for testing.

Dataset B corresponds to a set of 26,252 French transcripts having 96 possible actions (i.e., 96 outcomes, labels, or classes). The transcripts were obtained by applying a third-party speech-to-text system to 26,252 recorded contact center interactions. The 96 possible actions correspond to 96 possible products which could have been offered by an agent during an interaction. The dataset was used with 0.2 train-test splits, 268 manually labelled transcripts, 134 transcripts used for determining the threshold, and 134 transcripts used for testing.

For both datasets, a transcript labelling pipeline, as disclosed in relation to FIG. 7 above, was applied. Pre-processing operations were performed to transform all text to lowercase and remove redundant characters (i.e., punctuation). In both datasets, certain noise types were observed such as concatenated words (e.g., “todayisnice” as opposed to “today is nice”) and wrongly mapped words (e.g., “oui oui” instead of “Huawei”). The noise ratio for both datasets is approximately 90%.

The results in the results table 1200 for approaches according to the present disclosure 1202 utilize an XGBoost model (as described in more detail above). The TF-IDF word n-gram model utilized French stopwords. An n-gram range of (1, 3) was used with a maximum of 70,000 features extracted. As shown in the results table 1200, a word level feature extractor (TF-IDF word n-gram) and a context-level feature extractor (Word2Vec) provide the highest performance across both datasets for single label prediction and multi label prediction. This approach outperforms the baseline BERT and ByT5 approaches for all settings. This demonstrates that the use of the combinational techniques of the present disclosure provide improved labeling performance compared to state-of-the-art neural network models. The use of the feature extraction techniques of the present disclosure thus help address the problems associated with neural network approaches' sensitivity to noise.

At this point it should be noted that contact assignment and natural language processing in accordance with the present disclosure as described above may involve the processing of input data and the generation of output data to some extent. This input data processing and output data generation may be implemented in hardware or software. For example, specific electronic components may be employed in a behavioral pairing module or similar or related circuitry for implementing the functions associated with task assignment in accordance with the present disclosure as described above. Alternatively, one or more processors operating in accordance with instructions may implement the functions associated with task assignment in accordance with the present disclosure as described above. If such is the case, it is within the scope of the present disclosure that such instructions may be stored on one or more non-transitory processor readable storage media (e.g., a magnetic disk or other storage medium), or transmitted to one or more processors via one or more signals embodied in one or more carrier waves.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method for automatic vectorization of plain-text transcript data, the method comprising:
obtaining, by at least one computer processor, a transcript comprising a plain-text representation of a call held between an agent and a contact;
obtaining, by the at least one computer processor, a multi-level feature extractor for extracting a plurality of natural language feature vectors from an input transcript, the multi-level feature extractor comprising a plurality of feature extraction models each of which producing a natural language feature vector of the plurality of natural language feature vectors, wherein each multi-level feature extractor extracts a different representation level of natural language features from within the transcript;
applying, by the at least one computer processor, multi-level feature extractor to the transcript thereby generating a plurality of intermediate natural language vectors;
creating, by the at least one computer processor, a vectorized representation of the transcript by weighting each intermediate natural language vector of the plurality of intermediate natural language vectors according to a corresponding weighting factor of a plurality of weighting factors, wherein each weighting factor of the plurality of weighting factors determines a contribution of a corresponding intermediate natural language vector to the vectorized representation; and
outputting, by the at least one computer processor, the vectorized representation of the transcript for use in a machine learning pipeline.

2. The method of claim 1 wherein the plurality of feature extraction models include two or more of:
a character-level feature extraction model; a word-level feature extraction model; at least one contextual-level feature extraction model, and a transcript-level feature extraction model.

3. The method of claim 2 wherein the character-level feature extraction model comprises a term frequency-inverse document frequency model of character n-grams.

4. The method of claim 2 wherein the word-level feature extraction model comprises a character level term frequency-inverse document frequency model of word n-grams.

5. The method of claim 2 wherein the at least one contextual-level feature extraction model comprises a trained embedding model.

6. The method of claim 5 wherein the trained embedding model is one of a trained word2vec model or a trained transformer model.

7. The method of claim 2 wherein the at least one contextual-level feature extraction model comprises a fuzzy embedding model.

8. The method of claim 1 wherein the plurality of weighting factors are binary valued.

9. The method of claim 1 wherein the step of creating the vectorized representation of the transcript comprises concatenating the plurality of intermediate natural language vectors weighted according to the plurality of weighting factors.

10. The method of claim 1 wherein the step of creating the vectorized representation of the transcript comprises concatenating a plurality of average values weighted according to the plurality of weighting factors, the plurality of average values corresponding to average values determined for each of the plurality of intermediate natural language vectors.

11. The method of claim 1 further comprising:
obtaining, by the at least one computer processor, the plurality of weighting factors prior to the step of creating the vectorized representation of the transcript.

12. A non-transitory computer readable medium comprising instructions which, when executed by a device comprising at least one computer processor, cause the device to perform the steps of claim 1.

13. A system comprising at least one computer processor and a memory storing instructions which, when executed by the at least one computer processor, cause the system to perform the steps of claim 1.

14. A method for forming a pairing model for decisioning behavioral pairing in a contact center system, the method comprising:
obtaining, by at least one computer processor, a plurality of transcripts, each transcript of the plurality of transcripts comprising a plain-text representation of a call held within the contact center system, the plain-text representation having at least one substring associated with at least one action of a predetermined plurality of actions, wherein the predetermined plurality of actions include a plurality of relevant actions and one or more irrelevant actions;
filtering, by the at least one computer processor and using a relevance classifier, the plurality of transcripts to identify a plurality of relevant transcripts, wherein each of the plurality of relevant transcripts comprises a substring associated with one of the plurality of relevant actions;
determining, by the at least one computer processor and using an action classifier, a plurality of label vectors for the plurality of relevant transcripts, wherein a label vector for a relevant transcript indicates which of the plurality of relevant actions are associated with the relevant transcript; and
forming, by the at least one computer processor, a plurality of elements of a pairing model based on one or more agents associated with the plurality of relevant transcripts, one or more contact types associated with the plurality of relevant transcripts, and the plurality of label vectors, wherein an element in the plurality of elements is indicative of a probability that a contact-agent pairing will be associated with an action being taken.

15. A method for forming a pairing model for decisioning behavioral pairing in a contact center system, the method comprising:
obtaining, by at least one computer processor, a plurality of transcripts, each transcript of the plurality of transcripts comprising a plain-text representation of a call involving an agent of the contact center system and a contact having a contact type, the plain-text representation having at least one substring associated with at least one action of a predetermined plurality of actions, wherein the predetermined plurality of actions include a plurality of relevant actions and one or more irrelevant actions;
extracting, by the at least one computer processor, a plurality of natural language feature vectors from the plurality of transcripts using a feature extraction process;
obtaining, by the at least one computer processor, a relevance classifier which assigns a relevance score to a natural language feature vector, wherein the relevance score is indicative of a probability that a transcript associated with the natural language feature vector is associated with one or more of the plurality of relevant actions;
applying, by the at least one computer processor, the relevance classifier to the plurality of natural language feature vectors to identify a plurality of relevant natural language feature vectors from the plurality of natural language feature vectors, wherein the plurality of relevant natural language feature vectors are associated with a plurality of relevant transcripts of the plurality of transcripts which are related to the plurality of relevant actions;
applying, by the at least one computer processor, an action classifier to the plurality of relevant natural language feature vectors to determine a plurality of label vectors, wherein a label vector of the plurality of label vectors indicates which of the plurality of relevant actions are associated with a transcript associated with the label vector; and
forming, by the at least one computer processor, a plurality of elements of a pairing model based on one or more agents associated with the plurality of relevant transcripts, one or more contact types associated with the plurality of relevant transcripts, and the plurality of label vectors, wherein an element in the plurality of elements is indicative of a probability that a contact-agent pairing will be associated with an action being taken.

16. The method of claim 15 further comprising:
outputting, by the at least one computer processor, the pairing model for decisioning behavioral pairing in the contact center system.

17. The method of claim 15 further comprising, after forming the pairing model:
determining, by the at least one computer processor, a plurality of possible contact-agent pairings among a plurality of contacts waiting for assignment and at least one agent available for assignment, wherein the plurality of possible contact-agent pairings is determined from a first dimension of the pairing model and a second dimension of the pairing model; and
selecting, by the at least one computer processor, a first contact-agent pairing for assignment in the contact center system, wherein the first contact-agent pairing is selected from the plurality of possible contact-agent pairings based on a third dimension of the pairing model.

18. The method of claim 17 wherein the first dimension is an agent dimension associated with a plurality of agents of the contact center system, the second dimension is a contact dimension associated with a plurality of contact types of the contact center system, and the third dimension is an action dimension associated with the predetermined plurality of actions.

19. The method of claim 15 wherein the predetermined plurality of actions correspond to a plurality of offers to be offered by a plurality of agents of the contact center system.

20. The method of claim 15 wherein the feature extraction process comprises the method of claim 1.

21. A non-transitory computer readable medium comprising instructions which, when executed by a device comprising at least one computer processor, cause the device to perform the steps of claim 15.

22. A system comprising at least one computer processor and a memory storing instructions which, when executed by the at least one computer processor, cause the system to perform the steps of claim 15.

23. A method for decisioning behavioral pairing in a contact center system, the method comprising:
obtaining, by at least one computer processor communicatively coupled to and configured to operate in the contact center system, a pairing model comprising a plurality of elements determined from transcript data related to calls within the contact center system involving a plurality of agents and a plurality of contact types, wherein an element of the plurality of elements is indicative of a probability that a contact-agent pairing will be associated with an action of a plurality of possible actions being taken, the probability determined from instances of offered and taken actions appearing within the transcript data and instances of offered and refused actions appearing within the transcript data;
determining, by the at least one computer processor, a plurality of possible contact-agent pairings among a plurality of contacts waiting for assignment and at least one agent available for assignment, wherein the plurality of possible contact-agent pairings is determined from an agent dimension and a contact type dimension of the pairing model; and
selecting, by the at least one computer processor, a first contact-agent pairing for assignment in the contact center system using the contact type dimension and an action probability dimension of the pairing model, wherein the first contact-agent pairing is selected to increase a likelihood of the contact-agent pairing resulting in an action being offered and taken.

24. A method for decisioning behavioral pairing in a contact center system, the method comprising:
obtaining, by at least one computer processor communicatively coupled to and configured to operate in the contact center system, a pairing model comprising a plurality of elements determined from transcript data related to calls within the contact center system involving a plurality of agents and a plurality of contact types, wherein an element of the plurality of elements is indicative of a probability that a contact-agent pairing will be associated with an action of a plurality of possible actions being taken, the probability determined from instances of offered and taken actions appearing within the transcript data and instances of offered and refused actions appearing within the transcript data;
determining, by the at least one computer processor, a plurality of possible contact-agent pairings among a plurality of contacts waiting for assignment and at least one agent available for assignment, wherein the plurality of possible contact-agent pairings is determined from an agent dimension and a contact type dimension of the pairing model; and
selecting, by the at least one computer processor, a first contact-agent pairing for assignment in the contact center system, wherein the first contact-agent pairing is selected from the plurality of possible contact-agent pairings based on a plurality of possible action probabilities determined from an action probability dimension of the pairing model.

25. The method of claim 24 wherein the action probability dimension relates to a plurality of potential offers to be offered by the plurality of agents.

26. The method of claim 25 wherein the first contact-agent pairing is selected based on the action probability dimension of the pairing model and a resource availability.

27. A non-transitory computer readable medium comprising instructions which, when executed by a device comprising at least one computer processor, cause the device to perform the steps of claim 24.

28. A system comprising at least one computer processor and a memory storing instructions which, when executed by the at least one computer processor, cause the system to perform the steps of claim 24.

29. A method for labeling transcripts within a contact center system, the method comprising:
obtaining, by at least one computer processor, a plurality of transcripts, each transcript of the plurality of transcripts comprising a plain-text representation of a call held within the contact center system, the plain-text representation having at least one substring associated with at least one action of a predetermined plurality of actions, wherein the predetermined plurality of actions include a plurality of relevant actions and one or more irrelevant actions;
filtering, by the at least one computer processor and using a relevance classifier, the plurality of transcripts to identify a plurality of relevant transcripts, wherein each of the plurality of relevant transcripts comprises a substring associated with one of the plurality of relevant actions;
determining, by the at least one computer processor and using an action classifier, a plurality of label vectors for the plurality of relevant transcripts, wherein a label vector for a relevant transcript indicates which of the plurality of relevant actions are associated with the relevant transcript; and
outputting, by the at least one computer processor, the plurality of relevant transcripts and the plurality of label vectors for use within a decisioning process of the contact center system.

30. A method for labeling transcripts within a contact center system, the method comprising:
obtaining, by at least one computer processor, a plurality of transcripts, each transcript of the plurality of transcripts comprising a plain-text representation of a call held between an agent of the contact center system and a contact, the plain-text representation having at least one substring associated with at least one action of a predetermined plurality of actions, wherein the predetermined plurality of actions include a plurality of relevant actions and one or more irrelevant actions;
extracting, by the at least one computer processor, a plurality of natural language feature vectors from the plurality of transcripts using a feature extraction process;
obtaining, by the at least one computer processor, a relevance classifier which assigns a relevance score to a natural language feature vector, wherein the relevance score is indicative of a probability that a transcript associated with the natural language feature vector is associated with one or more of the plurality of relevant actions;
applying, by the at least one computer processor, the relevance classifier to the plurality of natural language feature vectors to identify a relevant natural language feature vector from the plurality of natural language feature vectors, wherein the relevant natural language feature vector is associated with a relevant transcript of the plurality of transcripts which is related to the plurality of relevant actions;
applying, by the at least one computer processor, an action classifier to the relevant natural language feature vector to determine a label vector for the relevant transcript, wherein the label vector comprises a plurality of label values each of which associated with an action of the plurality of relevant actions such that the label vector indicates which of the plurality of relevant actions are associated with the relevant transcript; and
outputting, by the at least one computer processor, the relevant transcript and the label vector for use within a decisioning process of the contact center system.

31. The method of claim 30 wherein the relevance classifier comprises a binary classifier trained on a training set of transcripts each of which known to have at least one substring associated with at least one action of the predetermined plurality of actions.

32. The method of claim 31 wherein the binary classifier comprises a binary extreme gradient boosting classifier.

33. The method of claim 30 wherein the action classifier comprises a multi-class classifier trained on a training set of transcripts each of which known to have at least one substring associated with at least one relevant action of the plurality of relevant actions.

34. The method of claim 33 wherein the multi-class classifier comprises a multi-class extreme gradient boosting classifier.

35. The method of claim 30 wherein the plurality of actions correspond to a plurality of offers and the plurality of relevant actions correspond to a plurality of relevant offers.

36. The method of claim 30 further comprising, prior to the step of extracting the plurality of feature vectors:
applying, by the at least one computer processor, one or more pre-processing operations to the plurality of transcripts.

37. The method of claim 36 wherein the one or more pre-processing operations include one or more of: a text truncation; a data augmentation; a data cleaning; and a spell checking.

38. The method of claim 30 wherein the feature extraction process comprises the method of claim 1.

39. A non-transitory computer readable medium comprising instructions which, when executed by a device comprising at least one computer processor, cause the device to perform the steps of claim 30.

40. A system comprising at least one computer processor and a memory storing instructions which, when executed by the at least one computer processor, cause the system to perform the steps of claim 30.

41. A method for training a transcript labeling pipeline, the method comprising:
obtaining, by at least one computer processor, a plurality of transcripts, each transcript of the plurality of transcripts comprising a plain-text representation of a call held between an agent and a contact, the plain-text representation having at least one substring associated with at least one action of a predetermined plurality of actions, wherein the predetermined plurality of actions includes a plurality of relevant actions and one or more irrelevant actions;
obtaining, by the at least one computer processor, an action vector associated with a subset of the plurality of transcripts, the action vector comprising, for a transcript within the subset of the plurality of transcripts, an action of the plurality of relevant actions, wherein the action is associated with a substring within the plain-text representation of the transcript;
deriving, by the at least one computer processor, an indicator vector from the action vector, wherein the indicator vector identifies the subset of the plurality of transcripts within the plurality of transcripts;
extracting, by the at least one computer processor, a plurality of natural language feature vectors from the plurality of transcripts using a feature extraction process, the plurality of natural language feature vectors comprising a subset of natural language feature vectors corresponding to the subset of the plurality of transcripts;
generating, by the at least one computer processor, a coarse classifier by training a binary classifier using the plurality of natural language feature vectors and the indicator vector, wherein the coarse classifier estimates, for a natural language feature vector associated with a transcript, a probability that the transcript is related to the plurality of relevant actions;
generating, by the at least one computer processor, a granular classifier by training a multi-class classifier using the subset of natural language feature vectors and the action vector, wherein the granular classifier determines, for the natural language feature vector associated with the transcript, a label vector having a plurality of label values associated with the plurality of relevant actions, each label value of the plurality of label values indicating whether the transcript comprises a substring associated with a relevant action of the plurality relevant actions;
forming, by the at least one computer processor, the transcript labeling pipeline from the feature extraction process, the coarse classifier, and the granular classifier, wherein a natural language feature vector is passed to the granular classifier when an estimated probability determined by the coarse classifier for the natural language feature vector exceeds a predetermined threshold; and
outputting, by the at least one computer processor, the transcript labeling pipeline for use within a contact center system.

42. The method of claim 41 wherein the plurality of actions correspond to a plurality of offers and the plurality of relevant actions correspond to a plurality of relevant offers.

43. The method of claim 41 wherein the binary classifier is trained using a semi-supervised training method.

44. The method of claim 43 wherein the semi-supervised training method comprises repeatedly retraining the binary classifier on the plurality of natural language feature vectors and the indicator vector using a self-training approach.

45. The method of claim 41 wherein an empty label vector is provided as output from the transcript labeling pipeline when the estimated probability does not exceed the predetermined threshold.

46. The method of claim 41 wherein the binary classifier comprises a binary extreme gradient boosting classifier.

47. The method of claim 41 wherein the multi-class classifier comprises a multi-class extreme gradient boosting classifier.

48. The method of claim 41 wherein each label value of the plurality of label values is binary valued.

49. The method of claim 48 further comprising, after generating the granular classifier:
identifying, by the at least one computer processor, a thresholding operation to convert the label vector to a binary-valued label vector, wherein the thresholding operation is included as part of the transcript labeling pipeline.

50. The method of claim 49 wherein the thresholding operation is based on a threshold identified using a hold-out set of transcripts known to be associated with the plurality of relevant actions.

51. The method of claim 50 wherein the threshold is identified using a grid search.

52. The method of claim 41 further comprising, prior to the step of extracting the plurality of natural language feature vectors:
applying, by the at least one computer processor, one or more pre-processing operations to the plurality of transcripts.

53. The method of claim 52 wherein the one or more pre-processing operations include one or more of: a text truncation; a data augmentation; a data cleaning; and a spell checking.

54. The method of claim 41 wherein the feature extraction process comprises the method of claim 1.

55. A non-transitory computer readable medium comprising instructions which, when executed by a device comprising at least one computer processor, cause the device to perform the steps of claim 41.

56. A system comprising at least one computer processor and a memory storing instructions which, when executed by the at least one computer processor, cause the system to perform the steps of claim 41.
